(19) United States
(12) Patent Application Publication
(10) Pub. No.: US 2002/0010639 A1
(43) Pub. Date: Jan. 24, 2002

(54) Computer-based interpretation and location system

(76) Inventors: Paul D. Howey, Crete, IL (US); David C. Howey, Tinley Park, IL (US)

Correspondence Address: MCDONNELL BOEHNEN HULBERT & BERGHOFF, 300 SOUTH WACKER DRIVE, SUITE 3200, CHICAGO, IL, 60606, US

(21) Appl. No.: 09/833,726

(22) Filed: Apr. 12, 2001

Related U.S. Application Data
(63) Continuation-in-part of application No. 09/550,383, filed on Apr. 14, 2000.
(63) Continuation-in-part of application No. 09/550,396, filed on Apr. 14, 2000.
(63) Continuation-in-part of application No. 09/550,382, filed on Apr. 14, 2000.
(63) Continuation-in-part of application No. 09/724,537, filed on Nov. 28, 2000.

(51) Int. Cl. G06F 17/60; G06F 17/30; G06F 15/16

(52) U.S. Cl. 705/26; 707/3; 707/10; 707/5; 709/219

(57) ABSTRACT

A system for a computer user to view a specific item over a computer network, such as the Internet. A computer user may enter a request in the search box generated by a small program on the user's computer, on Internet browser command line, or in a seach box on the site of a web vendor. The words entered by the user are interpreted by the system, and the user is promptly linked to a Web page specifically relating to the item described. Such interpretation includes searching for synonyms, consideration that spaces should be added or that the request is made up of multiple words, interpreting the request if it is written in slang. Further, the analysis ensures that entries describing the same item in different ways are directed to the identical web page. In addition, the system may use trend analysis to more accurately predict to what a particular request is referring. Accordingly, the process of navigating the Web in order to obtain an item over the Internet becomes substantially easier and more intuitive.

### BACKGROUND

The present invention relates generally to a specific-item network technology, and, more particularly, to a system for locating a specific item on the Internet or other large computer network. The Internet is a collection of computers and computer networks that freely exchange information among each other. As used in this document, the Internet refers to the current worldwide network of computers and any subsequent networks, such as Internet2.

The communication among computers on the Internet is accomplished through a variety of processes. The World Wide Web “Web” or “www” employs one such process of the Internet. A Web server computer (Web server or Web site) may present, or host, pages of information. A remote computer (client computer or user computer) may download a Web page from the site, thus allowing a remote computer user to view the page.

Each page on the Web can be a combination of text, pictures, audio and video clips or other information. The Web is typically characterized by hyperlinks, which allow a user, by clicking a computer mouse, to pick a particular object and then view another Web page that is associated with the hyperlink.

Web pages are typically provided with a standard set of tags or headers that define how the Web page is to be displayed. Headers control the display of the text, graphics and other such features of the Web page.

A browser is an application program used by those wishing to request to receive and display Web pages. More particularly, the software enables and translates the digital bits received into pictures and text so that the viewer may look at them. A browser is thus responsible for displaying documents to a computer and allowing a computer user to “surf” the Internet, moving from one Web site to another.

As used in this document, a browser is any software and/or device that allows a user to access resources on a large computer network. Thus, the term, browser, includes traditional browsers (such as the Netscape Navigator browser and Microsoft's Internet Explorer program) and other programs or devices that allow a user to have access to the Internet. The user typically instructs the browser what address to seek a resource from on the Internet by entering a command, or address on the command, or address, line of the browser. As used in this document, any instructions, or commands, given to a browser regarding where to seek a resource (regardless of how the information is conveyed to a computer) should be considered interchangeable. Similarly, any actions taken by a user to communicate to a computer (such as clicking a mouse, hitting a keyboard button, touching a screen or speaking a sound) should be considered interchangeable methods of acting with respect to the computer.

Each Web page or computer on the Web corresponds to an Internet address. More particularly, an Internet address, or Universal Resource Locator (“URL”), is a string expression that can represent a resource on the Internet. In a general sense, a typical Internet address, or domain name, includes the following components, reading from left to right: a general protocol extension; a second-level (or unique) domain; and a top (or high) level domain extension.

For example, for the URL, “http://www.ABC.XYZ.com.uk”:

“http” may be considered a general protocol extension that instructs a browser that the hypertext transport protocol should be used when searching for the address; http is the default, or native, protocol of the Internet and is currently used by most Web servers and client browsers to communicate over the Internet (protocol extension).

“C://” is a separator (protocol extension). “www.” is a sub-domain protocol extension that instructs the browser that the computer user seeks information on the Web (protocol extension).

“ABC.XYZ”, is the second-level (or unique) domain.

“.com” is a generic, top level domain (domain or protoco extension).

“.uk” is a country code top level domain (domain or protocol extension).

In the present context, for the URLs, “http://www.XYZ.com”, “http://www.XYZ.co.uk”, and “http://www.XYZ.ABC.com”, everything except “XYZ“and “XYZ.ABC” should be considered an extension. In these examples, “XYZ.com”, “XYZ.com.uk” and “XYZ.ABC.com” are the designations of computers or host sites on the Web. These designations may be considered as made up of the site names, “XYZ“and “XYZ.ABC”, and additional extensions, ”.com” and ”.co.uk”.

For any such URL, there is an equivalent Web address: the computer's numeric Internet Protocol Address. The numeric IP address may be derived from the computer's URL pursuant to the Internet's Domain Naming System.

The “.com” protocol extension is commonly used to designate a commercial organization, primarily in the United States. Other such protocol extensions also now exist:

“.edu” is typically assigned to an educational institution in the United States;

“.gov.” is typically assigned to the United States government;

“.org” is typically assigned to a non-profit making organization;

“.mil.” is typically assigned to the United States military;

“.net” is typically assigned to a network provider, such as an Internet Service Provider; and

“.arpa” is typically assigned to an old-style ARPA-net address. The set of protocol extensions for the Internet may be expanded in the future to include other extensions. It has been reported, for example, that the Internet Corporation for Assigned Names and Numbers selected, on Nov. 16, 2000, seven further protocol extensions: “.biz”; “.info”; “.name”; “.pro” “.aero”; “.museum”; and “.coop”.

Protocol extensions also include national extensions, where international boundaries are crossed. Such protocol extensions generally follow the organizational extension and include, for example, “.ar” for Argentina, “.at” for Austria, “.au” for Australia and “.uk” for the United Kingdom. As used in this document, the term, “protocol extension”, should be deemed to include both the present and future protocol extensions of Internet addresses.

The terms on either side of the actual site name, such as “http://” or “www”, which typically precede the site name, or “.com” or “.gov” or “.uk”, which typically follow the site name, are deemed in this document to be protocol extensions of the site name. Currently or in the future, some hardware or software associated with browsers may automatically insert some or all of the protocol extensions before, during or after the site name has been entered by a user in a browser command line (rather than requiring the user to insert such protocol extensions).

After a request for a valid Web address is entered into the address/command line of a browser, the request is forwarded to the Web server that supports the Web page. When the appropriate server receives the request, it transmits the Web page content to the client computer. The client computer then typically displays the Web page.

Applicants typically register a domain name electronically. Periodic maintenance fees for each name are generally required after registration.

Computer networks, and particularly the Web, can transmit information among large numbers of people. The extended economic expansion of the United States in the 1990s has been attributed in part to the success of the Internet in stimulating the U.S. economy and increasing economic efficiencies.

The popularity of the Internet has let to increased complexity. As of early 2000, there were reported to be over 10 million Internet domain names registered with over 8 million of such registrations being “.com” domain registrations. Newsweek, Apr. 17, 2000, at p. 68. See also, e.g., the Web site: www.domainstats.com; H. Newton, Newton 's Telecom Dictionary (16^{th} ed. February 2000)(Telecom Books) at page 273 (Domain Definition), stating that there are over 100 million domain name addresses. At present, the Web sites of the Internet are not arranged in any fully consistent manner, nor are the Web sites themselves always arranged in a logical, consistent or easily searchable manner.

The entry of a subject or name followed by an extension, such as “.com”, will not necessarily lead to a site of interest. For example, in November 2000, entering on the command line, “whitehouse.com”, brings the user to a Web server displaying adult, sexually oriented material. (The browser request, www.whitehouse.gov, however, does bring the user to the Web site associated with the President of the United States.) Similarly, in March 2000, entering the browser request, “ingroundpools.com,” brought the user to still another adult, sexually oriented site rather than one having products or information regarding swimming facilities.

A computer user wishing to obtain an item over the Internet now must often take considerable time and effort to find the appropriate Web site. For example, a purchaser wishing to buy a specific item must know how or where on the Internet to find it. This may cause the purchaser to become frustrated- The frustration may be particularly acute when the user is not experienced in finding Web sites or does not know the item's distributor(s) or manufacturer(s), but, rather, only knows that she wants to buy a particular product or service.

To help users maneuver among Web sites on the Internet, there exist a variety of search engines. Search engines are programs that return a list of Web sites, or URLs, that match user-selected criteria. Once a user reaches a search engine (typically by entering the search engine's address in the command/address line of a browser), the user is asked to enter relevant search criteria on the search engine's own request line. The search engine then presents to the user, or viewer, another page that often sets forth a substantial list of Web site locations that relate to the user-designated criteria.

The contents of such search results are commonly hypertext links. The user may activate one of the links to view the referred site (or page). The site may not be of interest, however, and, even if it is, may still require the user to spend considerable time navigating the one Web site (and downloading still more pages) to find the item of interest.

In particular, a retail Web site often has a home page, which is the first, or welcome, page that a user encounters after entering the Web site address. The home page often provides only general information about the hosting organization. It may be considered, for example, the “front page” on an “online brochure” about the organization. It often includes a table of contents or access to another search engine to help the user find more information on the site. However, specific items on the other, non-Home pages of a Web site can often be located only with substantial effort and time. The process of finding a particular page “beneath” the home, or welcome, page may be referred to as “drilling” the site. Drilling for information can often prove time consuming and frustrating for computer users.

The search engines may routinely scour the Web and categorize the Web sites according to selected content terms. However, the search engines often do not promptly find specific items of interest. A computer user who desires to buy an electric drill may input “electric drill” in the search request line of a search engine, for example, and receive, in response, links to information about power tools generally or information on how electric drills are made. For example, users attempting to purchase a particular item over the Internet commonly must take numerous actions (such as, e.g., “clicking” a computer mouse button), and then view a variety of different Web sites, before possibly coming to a Web site, or a portion of a Web site, that shows what the user wants.

Commentators have observed that the computer and Internet are not easy for a good portion of the population. As set forth, for example, in the Mar. 16, 2000 issue of the Chicago Tribune: “Blame the computer not the user for technology frustrations . . . Computers and the Internet promise to invade every aspect of daily life, which is fine if you know how to use them. But many don't.” Nonetheless, despite widespread recognition that the Internet remains difficult for many to navigate, the complexities of the Internet and electronic commerce (“E-commerce”) over the Internet remain, in substantial measure, because of the often-disorganized nature of the Internet content.

While, for example, a typical library holds a large number of books on a variety of subjects, the books are usually arranged in general categories and catalogued to help a library user more easily find books on a particular subject. While Web search engines attempt to systematically provide subject matter categories and return Web site listings that use particular words, such automated cataloguing is often ineffective to bring a user promptly to a desired item on the Web.

The term, item, as used in this document, denotes the object of a user's search, such as, for example, a piece of specific information or the section of a Web page that allows the user to buy a specific product or service. A user must often download many “wrong” sites before possibly finding the desired item. This may cause substantial frustration, especially for users who do not use computers regularly.

Many computer users thus find the experience of attempting to find items over the Internet confusing or frustrating. Even after finding a site that sells a variety of different products, a purchaser still must often perform substantial navigation before reaching an item of interest. The process must often be repeated for each different product that a consumer evaluates. Such an approach is not easy or intuitive for many computer users.

Indeed, even some of the best Web sites currently available on the Internet may still provide a barrier to shopping for some computer users. For example, the December 2000 issue of Ziff Davis Smart Business for the New Economy gushes that two Web sites “made quick work of shopping; it took testers less than two minutes to find and purchase their items” (pp. 106-107). For many people, having to spend two minutes to locate a desired item, even after they have reached the correct Web site, is undesirable.

The content of many Web sites and search engines is presented in the English language. Navigating among Internet Web sites and utilizing tools of the Internet, such as search engines, becomes even more difficult for a user that is not fluent in English.

Further, each time that a computer user goes to a different Web site, the Web site must be downloaded onto the computer. This takes time and adds to the frustration of the Internet experience. Moreover, to the extent that the user has a slower modem or is viewing a more complex Web site, the user will experience an even longer delay before viewing the Web site. While some may enjoy higher speed computer equipment and higher speed Internet connections, the delay associated with waiting for a Web page to download is frustrating for many.

Further, the concept of making a purchase over the Internet is of concern to many because of sensitive nature of the information being transmitted over a public network. Confidential data, such as a purchaser's name, address, credit card number, and demographic information are transmitted during a typical “E-commerce” transaction. Computer hackers may, for example, attack the sites of product vendors, surreptitiously retrieve the purchaser's confidential information and misuse it. Hence, customers' willingness to engage in E-commerce may be hampered by a concern that the confidential information provided to E-commerce vendors will not be secure.

Purchasing a variety of different products over the Internet often entails conducting business with a variety of different sellers, many of whom do not have established reputations for good business practices. Thousands of vendors now host Internet sales sites. Some are reliable; some are not. The risk of possibly dealing with an unreliable or unscrupulous vendor may discourage some people from making purchases over the Internet. Even if the purchaser is not concerned about the possible misuse of her credit card number or other information, she may nonetheless feel reluctant to purchase over the Internet because of a fear that the vendor will not be responsive to her complaints should an ordered product not arrive or arrive in a damaged condition.

Although some Web sites are well known, consumers purchase thousands of different products. Most consumers can remember only a relatively few Web site names. Even if a few of the sites can be bookmarked or stored on a computer as favorites, the proper site must still be first learned by the computer user and then stored on the computer. The user must then later remember what the various bookmarks stand for in order to make use of them and reduce the number of Web sites that she must download before making a purchase. Moreover, some Web sites have addresses for specific pages within the site that “expire” or may otherwise become unusable later. For such sites, a user may be thwarted in her attempt to activate a bookmark and return to a particular page that has proved helpful in the past.

Some sites have intuitive names, such as “cars.com”. However, such sites typically offer only a limited range of goods and services. Moreover, some apparently logical domain names, such as “whitehouse.com”, are misleading and do not necessarily lead the user to the item of interest.

A few Web sites selling a variety of different items are available from a single seller. However, some such sites may offer only a small fraction of the total universe of products sought by purchasers. Others may only sell one brand of product. Still other such sites are only portals to still other sites, rather than a Web page displaying the item of interest: thus, purchasers must download still more information before finding what they want.

Some merchants do sponsor Internet sites that provide a variety of different products or items. However, even if a computer user is able to locate a particular merchant's web site, the site may still not allow the user to quickly or easily locate the item of interest. Often, there are a substantial number of actions and decisions that a user must endure before viewing the item of interest.

For example, assume that a user wishes to purchase a Personal Digital Assistant/handheld computer sold by Palm, Inc. and reaches the Internet site of a retailer selling a variety of consumer products. The user may keystroke a term, or query a search-engine box, on the web home page of the retailer. Upon “entering” the request or hitting a virtual “Go” button, a variety of responses may be provided, so that the user can scroll down through the responses. In many cases, search terms such as, PDA, pda, pdas, handheld, handhelds, Palms, or personal digital assistant, may not lead the user to the correct page to view the product desired. The user might then conclude that she had been too specific in specifying the search term and keystroke in, instead, computer or computers or computer peripherals. A large number of choices may then be presented before the user may possibly reach the item desired-a Palm brand handheld computer. In a substantial number of cases, the user may become discouraged or impatient and leave the site of the first retailer, either to find the site of another retailer or to give up on purchasing the device over the Internet.

Thus, the specific items desired by a purchaser may not always be quickly and easly accessible from presently available Internet sites. Accordingly, the problems of Ecommerce remain with such the present system for locating items over the Internet.

As used in this document, a computer includes devices such as Personal Digital Assistants (“PDAs”), cellular telephones, and any other user devices (some of which may not yet exist) that can receive informnation from and/or send informnation to a Web page or similar data source on a computer network. Similarly, the terms, computer user and user, should be considered to include anyone who uses an electronic device to send or obtain resources to or from the Internet or other network. Further, a computer system can be consdered a single computer as well as a collection of interconnected computers.

The greater acceptance of E-commerce is further limited by the capabilities of the computers used to download Web pages. Many computers, such as, for example, PDAs and cellular telephones, have less computing power, less memory and/or a smaller screen than conventional computers. Accordingly, such user devices with limited capabilities are not well adapted to receive Web site information. Complicated Web sites may not translate well to such limited or low-capability devices, leading to a confuising display, difficult navigation, and increased delay for a user that wishes to obtain information on a particular item.

### SUMMARY

An embodiment relates to a system for a computer user to find a specific item over a computer network, such as the Internet. A user may enter a request for an item. Such a request may be made in different formats. For example, the user may enter the request in a search box generated by a small application on the user's computer, on the command line of a web browser, or in the search box on the web site for a web retailer. (Such a small applicaton is a relatively small software program which may be loaded onto the user's computer ahead of time. The small application may not, but need not necessarily, be Java-capable.) Upon entering the name of the item requested, the system then determines a pre-established association between the user's request and a particular Web page pertaining to the request. Thus, the user is promptly linked to a Web page specifically relating to the item described (even if the Web page is below the initial page of the vendor selling the requested item). Accordingly, after taking only a limited number of actions and viewing only a limited number of screens, the user is able to locate a desired item.

In another embodiment, the system interprets the words entered by the user in order to increase the chance that the user will connect to the desired item. The system thus provides a better user experience to those who may mistype or misspell their requests. The system may also accept a foreign language entry word, converting the foreign language word to a common language (such as, for example, English), and then allowing the system to act on the request. In this way, a computer user may employ her or his native language for an enhanced search experience.

### BRIEF DESCRIPTION OF THE DRAWINGS

FIG. 1 is a diagram showing a user computer and server interconnected to a computer network, in accordance with the present invention;

FIGS. 2A-21 depict a user interface for a browser and show a series of exemplary requests entered onto a browser command/address line in order to utilize the present system;

FIGS. 3A-31 depict an alternative user interface for a browser and show a series of four exemplary requests entered onto the browser command/address line in order to utilize the present system;

FIG. 4 is an example of a listing of browser requests formed in accordance with the present system;

FIGS. 5A and 5B are further examples of browser requests formed in accordance with the present system;

FIG. 6 is an example of a Web initial page provided by the present system;

FIG. 7 is an example of a detail page provided by the present system in response to a request for additional information regarding a primary item shown in FIG. 6;

FIG. 8 is an example of a page provided by the present system in response to a request for additional items after the Web page of FIG. 6 has been displayed;

FIG. 9 is an example of a search page provided by the present system;

FIG. 10 is an example of an item attribute inquiry provided by the present system;

FIG. 11 is an example of an alternative item attribute inquiry provided by the present system;

FIG. 12 is an example of a Web page provided to a limited capability user device by the present system;

FIGS. 13A and 13B show an example of spelling assist screens provided by the present system;

FIGS. 14A-14C are diagrams showing a user device and a controlling organization's central computer interconnected to a computer network in accordance with the present system;

FIG. 15 is an example of an order confirmation issued by the present system;

FIG. 16 is an example of a user form to alert the system when the user wishes to be advised of price changes;

FIGS. 17A-17B are examples of notices of price change issued by the system;

FIG. 18 is an example of a quality inquiry issued by the system;

FIG. 19 shows example of a shopping cart information displayed by the system;

FIG. 20 is an example of a check out page displayed by the system;

FIG. 21 is an example of a distributor page displayed by the system;

FIG. 22 is an example of a distributor product page displayed by the system 14;

FIG. 23 is an example of a screen display on the user's computer, where an icon for activating a system browser is shown;

FIG. 24 is an example of a screen display on the user's computer, where the icon for activating a system browser, as shown in FIG. 23, has been activated;

FIG. 25 is an example of a search page for display on the user's computer;

FIG. 26 is a chart showing an example of a flow of orders and payments for the system;

FIGS. 27A-27B are charts showing alternative examples of a flow of orders and payments for the system of FIG. 14;

FIG. 28 is a diagram showing the steps that a user may taken when employing the system shown in FIG. 14;

FIG. 29 is a diagram showing simplified steps that a user may follow when employing the system shown in FIG. 14;

FIG. 30 is a diagram shown an example of steps that may be taken by the user's computer when employing the system shown in FIG. 14;

FIG. 31 is a diagram of the steps that a user may take who has a small application on her computer to assist in employing the system of FIG. 14;

FIG. 32 is a diagram showing the steps that may be taken by a small application on the computer of a user who employs the system shown in FIG. 14;

FIG. 33 is a diagram showing alternative steps that may be taken by a small application on the computer of a user who employs the system shown in FIG. 14;

FIG. 34 is a diagram showing selected processes employed by users of the system after the Web initial page is displayed;

FIG. 35 is a diagram showing a cascading ordering system employed by the organization controlling the system shown in FIG. 14;

FIG. 36 is a diagram showing a control procedure that may be followed by the organization controlling the system shown in FIG. 14;

FIG. 37 is a diagram showing a follow-up procedure that may be followed by the organization controlling the system;

FIG. 38 is a flow chart showing a process used at the server of the controlling organization;

FIG. 39 is a system search block which can be generated by a small computer program on the user's computer or which can appear on the web site of a source of items on the Internet; and

FIG. 40 is a flow chart showing an exemplary process utilized by the system to better interpret a user's request and determine the responsive web page.

### DETAILED DESCRIPTION OF THE PREFERRED EMBODIMENTS

Overview

The present system 20 relates to the direct item linking of items over a computer network, such as the Internet 22. The system 20 allows a computer user (not shown) who is seeking a particular item on the Internet to follow a more logical and simple approach to promptly finding the item. The user simply types onto the command, or address, line of a browser or search engine, or similar device, the name of the item. The computer may then add to the descriptor, as necessary, a common extension (such as, by way of example only, “.sales7”) and a protocol (or domain) extension (such as, by way of example only “.com”). Alternatively, of course, the user may type in such terms as the common extension and a protocol extension. The user is then promptly presented with the item. The item may be, for example, the named information or a screen offering to sell the named product.

This more intuitive approach to finding an item is possible because a single controlling organization oversees a substantial family of diverse Web addresses, Web pages and/or Web sites. Such an approach responds to the logical thinking of a consumer. “enter in what you want.” Thus, the system 20 makes substantially more intuitive the process of locating promptly an item or items of interest on the Internet. The consumer need not remember any manufacturer or distributor names or understand Boolean search engine logic. The consumer need only enter the name of the product she wants (and, if the computer does not automatically add it, the common and protocol extensions).

Generally, in order to supply a large number of different products or services, Ecommerce firms have often used a single Web address that corresponds to a single site and made the site large and complex. In contrast, the present system 20 attacks the problem of the Web's complexity in a global manner. Instead of the traditional approach of using one complex Web site corresponding to one address, the system 20 has “done the work” for users. A large number of descriptors may be used which are associated with a specific Web page requested by the user.

Upon entering an intuitive item descriptor, a computer (or the user) may then add a common extension and protocol extension, as appropriate, and the user is then directed to the specific page of interest. Accordingly, the specific page is generally significantly easier to get to, taking less time and fewer “mouse clicks” by the user.

The controlling organization drills sites (frequently doing the drilling manually rather than with a search tool or spider) to find a substantial number of specific pages of potential interest to users and then associate such “deep-link” pages to item requests likely to be made by users. Accordingly, the controlling organization has done the work for the user by “drilling” ahead of time so that the user can avoid the time and frustration associated with drilling.

Since the page presented to a user is more specifically directed to the item of interest, the page can also be smaller, less complex, and easier to understand. Because a large number of different item descriptors have already been “loaded” into the system 20 in a logical, user-friendly fashion, the user of the system need only enter the commonly understood name of a particular product (or service or type of information) (and, if necessary, a common extension and protocol extension(s) order to more promptly obtain the information desired.

Architecture of the System

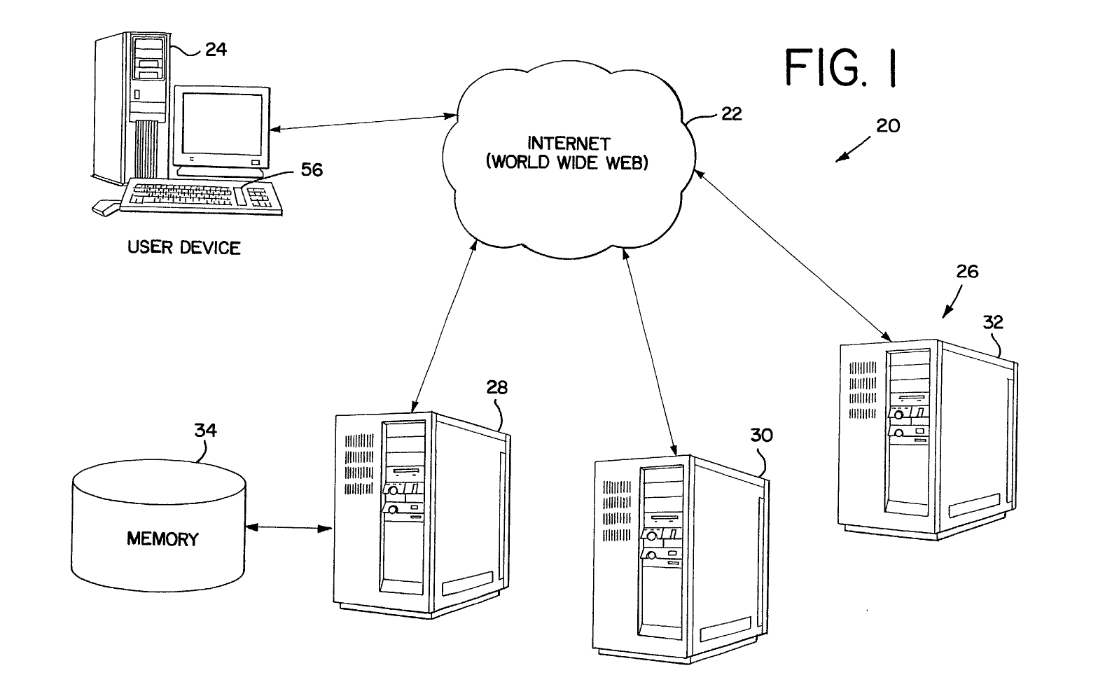

More particularly, as shown in FIG. 1, the system 20 relates to a user (or client) computer 24 (or group of user computers simultaneously) interconnected to a computer network, such as the Internet 22. The system 20 also employs at least one server. In the illustrative example of FIG. 1, a plurality of servers 26 (exemplary servers 28, 30, 32) are shown. The three servers 28, 30, 32 may be either discrete servers or virtual servers.

An illustrative data storage device or memory unit 34 is also shown associated with the server 28, although, of course, the other servers 30, 32 also include memories. Such memories may include program instructions and databases for carrying out the methods and system described in this document.

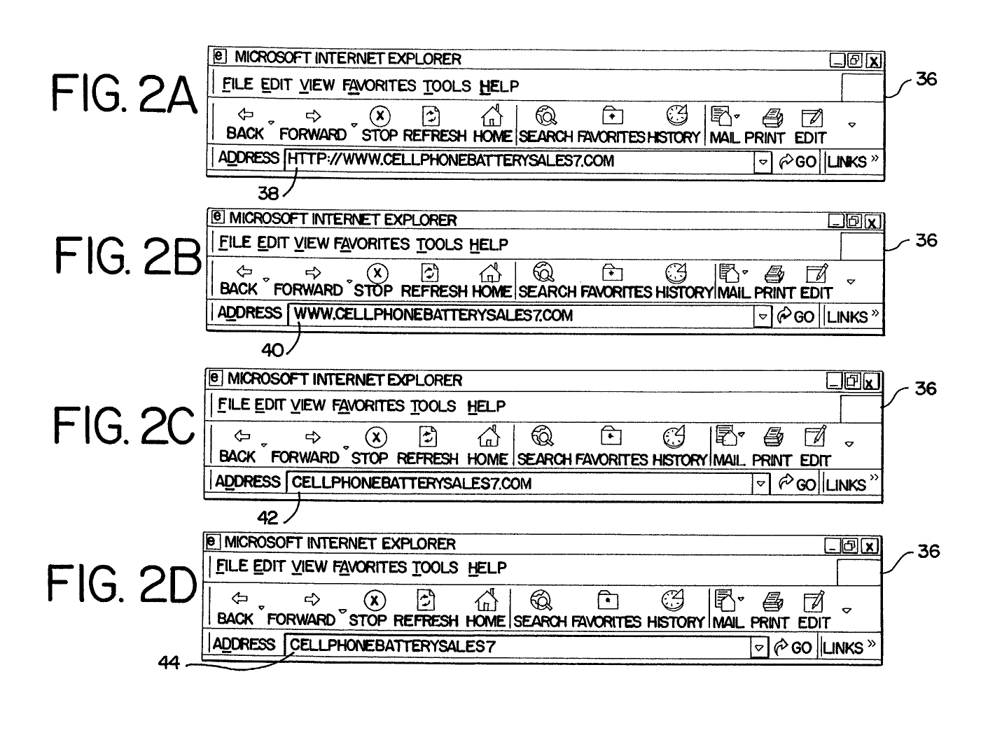

As shown in FIG. 2, the entries 38-47 may typically result in the server 28 responsively providing a link to one or more other servers who provide a page showing the requested item (such as, for example, cellular telephone batteries). In most cases, such a link is not to a general description of cellular telephone batteries, but, rather, to a specific page that allows the user to purchase cellular telephone batteries. This occurs because the controlling organization for the system 20 has previously made the effort to find the appropriate page on another server. Accordingly, because of the advanced work by the central organization that is overseeing and controlling the system 20 (“controlling organization”), the user is promptly linked to the correct page on the appropriate server. The user is, for example, promptly linked to a page offering cellular telephone batteries for sale, rather than simply being linked to the top, or home, page of a cellular telephone battery retailer.

Often, finding the correct page on a large, Internet Web site (which, for example, actually offers cellular telephone batteries for sale), can not be located automatically with commonly available computer search tools. Instead, applicants have learned that the location of the correct page for the thousands and thousands of items that users want must typically be done manually. A person must drill down in substantial numbers of Web sites, observe when an appropriate page has been located, and then record the page's address for possible later use by the system 20.

Many technologically savvy users of the Internet may assume that the best approach for helping a user of the Internet promptly obtains an item of interest is to develop an even more complex computer search program. Contrary to such a conventional thinking, however) applicants have discovered that, often, the best approach is to have a person (or group of people) manually drill Web sites, determine what pages are likely to be of interest and then associates that page with a key word, or item descriptor, that a user is likely to input when wanting to reach that particular page.

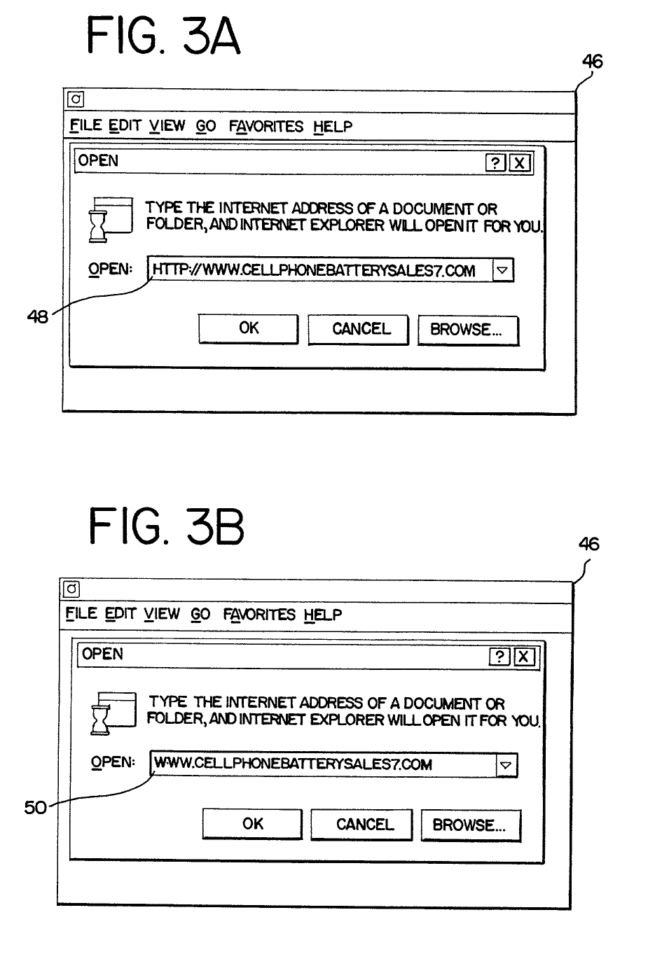

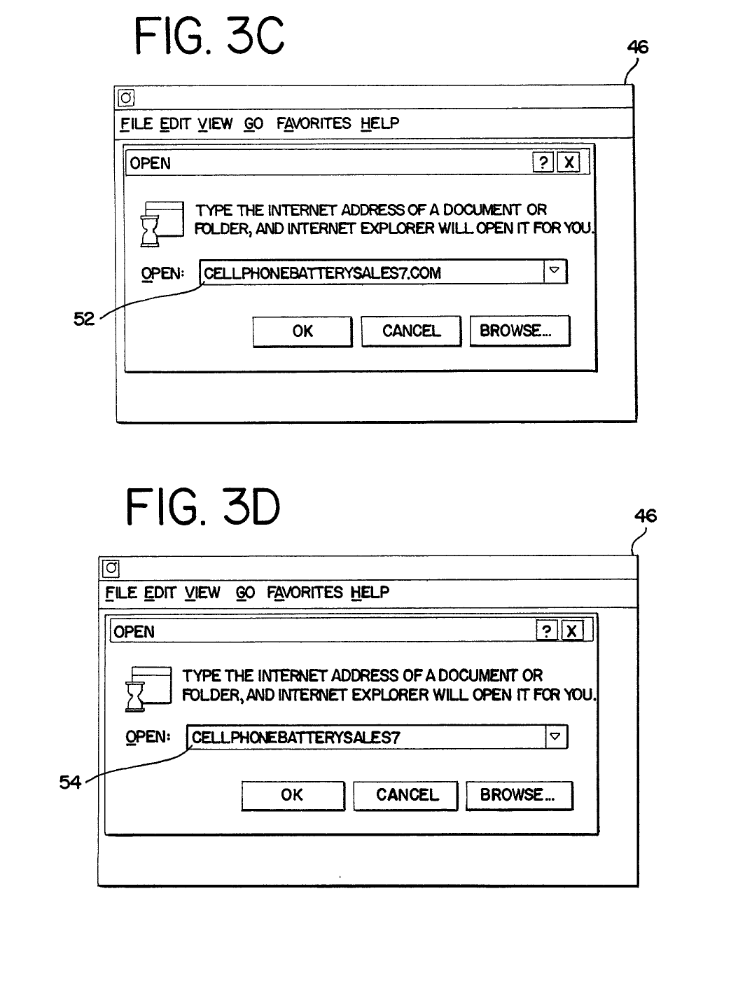

In accordance to one exemplary embodiment, the user may enter in a particular command, or Internet address, onto the command/address line of a browser. In FIG. 2, an exemplary browser interface 36 is shown, with exemplary command/address line entries 38-47. FIG. 3 shows an alternative browser interface 46, with exemplary command/address line entries 48-57.

With the system 20, the user need not employ a general search engine to eventually reach an item of interest (or a specific search engine found on a Web site of interest) nor scroll down and read a table of contents on, for example, a Web-site home page. Rather, the user may type in the command line an entry word/item descriptor and, if necessary, a common extension and protocol extension(s). The system 20 effectively acts as a “smart” search system, reducing the risk that the user will view a non-helpful or incorrect page in response to a request. The reduced risk stems from the system's Resource Location Features:

1. Item Descriptors. A substantial family of item descriptors are chosen and organized as key words to correspond to words that are likely to be entered by users. A common extension is generally added to an item descriptor entered by a user. The common extension may be added by, for example, the user's computer or by the user herself.

2. Deep-Links. Rather than, for example, providing links to general home pages or pages that may be only tangentially related to the requested item, the system 20 provides specific Web pages that have been pre-selected by the controlling, or central, organization (typically selected manually rather than with an automatic search tool or spider) and that are associated with the item descriptors/key words used by the system 20.

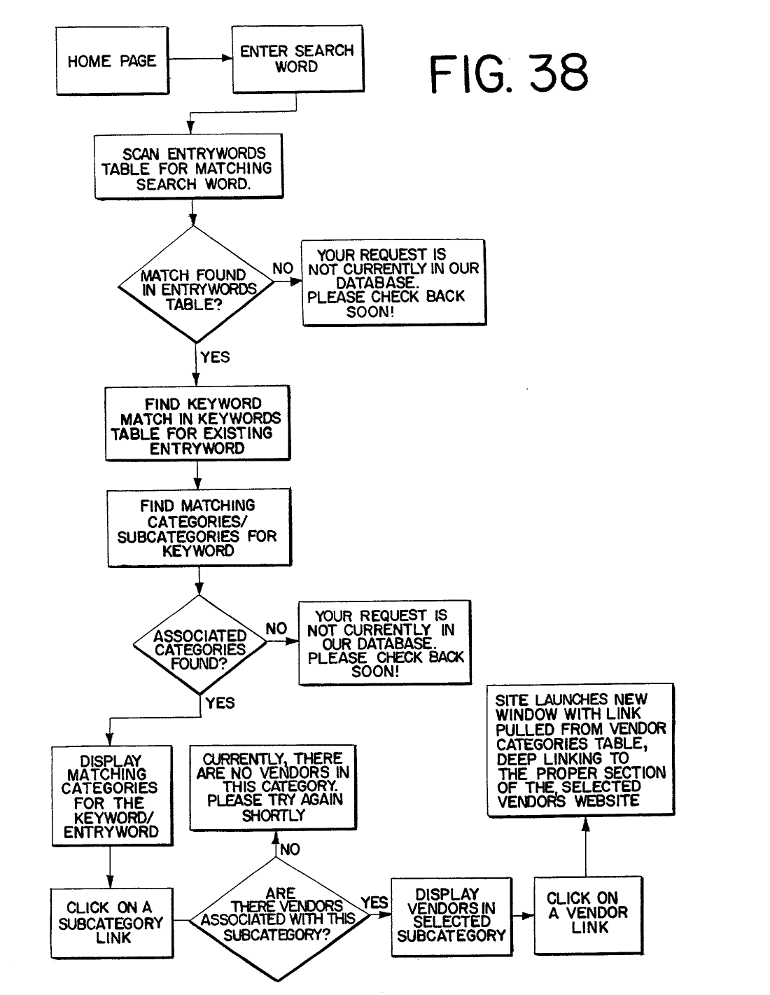

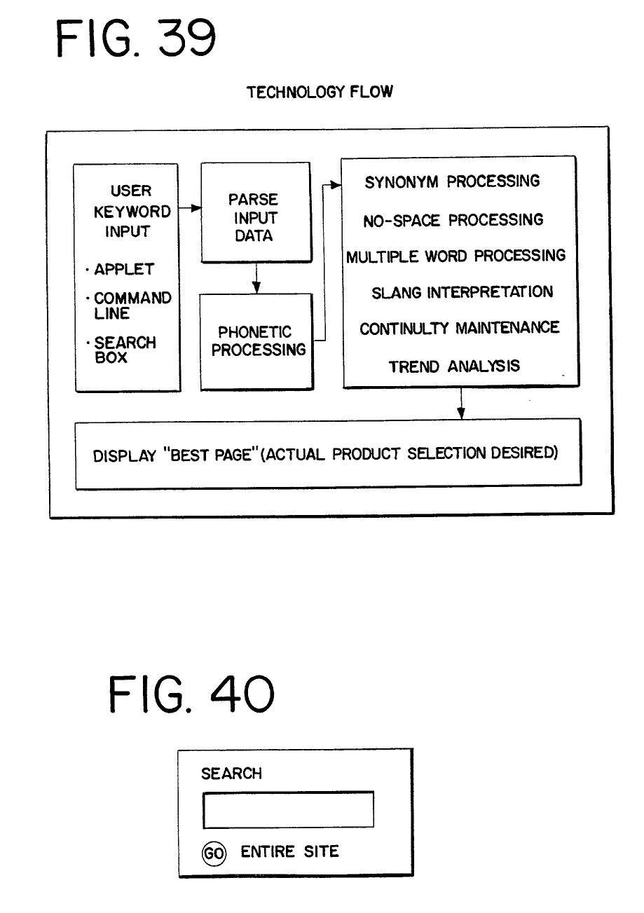

3. An Interpretive Entry System (“IES”). The IES interprets inputs from the user and forwards the interpretation to the rest of the system 20, further helping the system 20 increase the probability that the user is promptly taken to a responsive deep-link page. Each of these attributes of the system 20 is described more fully below. Flow-charts for the processes implemented by the Interpretive Entry System are shown in FIGS. 38 and 39.

Resource Location Features

1. ITEM DESCRIPTORS

a. Generally

An item descriptor is a commonly understood word or collection of words that represent an item of interest. Item descriptors may include words entered by a user or key words or categories utilized by the system 20.

In one embodiment, the system 20 responds to purchasers who what to buy a specific consumer product or service. In other embodiments, the system 20 responds to computer users who wish to buy business or industrial products, obtain services, or obtain information about a particular subject.

For purposes of illustration, consider the exemplary implementation of the system 20, which relates to products and services for consumers In this case, the item descriptors are specific product or service names. In contrast to a general category or an industry name, such as “electronics,” or a product line name, such as “games,” the system 20 also utilizes a specific subcategory or item descriptor, such as “gamecontroller” or “videogame peripheral”. The item descriptors used by the system 20 are assembled to correspond to the words entered by users, as those entry words are interpreted by the system 20.

For example, the system 20 uses the item descriptors/key words/categories, “Christmas tree decoration”, and “christmastreelights”, in addition to using the more general industry product line names of “seasonal items” or “lighting products.” In a like manner, the system 20 uses the item descriptor/key word/category, “campstove”, in addition to the more general industry category or product lines names of “sporting goods” or “outdoor gear”.

The item descriptors used within the system 20 are selected with the consumer in mind. As those of ordinary skill in the art appreciate, consumers generally have come to learn a diverse set of names for the products and services that they want. Consumers generally know that, upon using a particular descriptor in, say, a request to a store clerk, the clerk will usually be able readily to direct them in the store to the specific item of interest. In a like manner, consumers generally know what specific item descriptor to use when looking up an item of interest in a Yellow Pages telephone directory.

An analogous approach is used within the system 20 to choose item descriptors and to establish the corresponding individual Web pages or Web sites. The descriptors and associated Web pages/sites correspond to the diverse family of descriptors that purchasers have generally come to know for most products and services.

In one preferred embodiment, the item descriptors are sufficiently specific such that, when a user enters a request for an item, a responsive sampling of the specific products or services desired by the user is legibly displayed on a single computer screen. In another exemplary implementation, the item descriptors generally do not include features, such as color, size or ingredients.

The item descriptors used by the system 20 are collectively referred to as the family of item descriptors. The family of item descriptors corresponds to the names of the different products or services that are routinely called for by purchasers (or computer users) and supplied by the system 20. The family of item descriptors is referred to as being diverse, since it includes a substantial portion of the items called for by the intended audience.

In one embodiment of the system 20 relating to consumer products, the family of item descriptors is diverse because it includes a substantial portion of consumer products. In another, alternative embodiment, the family is diverse because it includes a substantial portion of products within a particular product line and includes products from a plurality of manufacturers.

In another embodiment, the family of item descriptors is diverse because it includes a substantial portion of consumer products, where the descriptors include trademarks associated with consumer goods. In another, alternative embodiment, the family is diverse because it includes a substantial portion of products within a particular product line and includes products from a plurality of manufacturers, where the descriptors include trademarks associated with consumer goods.

The diversity of the family of item descriptors used by the system 20 reduces the risk that a consumer will use an item descriptor in a browser request and not locate the item of interest. The use of a diverse family of item descriptors will help consumers come to know that they need only enter the name of an item, a common extension and protocol extension, if necessary, in order promptly to obtain a desired item.

Numerous examples exist for the item descriptors used within the system 20. For the embodiment relating to consumer products and services, such item descriptors include, for example: telephotolens, cellulartelephone, basketball, tickets, basketballtickets, lightfixture, lightbulb, lighting equipment, christmaslight, italianfood, beachtowel, bassdrum, cosmetics, lighter, weddingcake, transmission, swiss chocolate, petfood, disposablediapers, babysitting, paint, etc. Such key words may be associated with the interpreted words entered by a user.

In another embodiment, the family of item descriptors also includes plural forms (telephones, cellular telephones, basketballs, basketballtickets etc.) as well as common misspellings of the words (e.g., celulartelefone, etc.) and slang terms and abbreviations for words (zitcream for acne cream; guitaramp for guitar amplifier, etc.).

In an alternative, exemplary embodiment, the family of item descriptors used by the system 20 may include only the singular or plural form of a particular word and not misspellings or slang or abbreviations. Rather, the system 20 includes an Entry Interpretation System that develops variations of the words entered by a user, which, in turn are compared to the family of item descriptors used the system 20. Thus, in looking for a “match”, the system 20 compares variations in the words entered by users (plurals, misspellings, slang, abbreviations, etc.) with the family of item descriptors (rather than comparing a single entry by the user with a larger list of item descriptors).

In one preferred embodiment, the variations of entry words are pre-established and residing within the system 20. In another embodiment, which utilizes more processing power and time, such tables are not loaded into the system 20 ahead of time but, rather, are generated “on the fly.”

In one embodiment, the item descriptor is a specific noun covering a particular product or service. In another embodiment, the item descriptor may be either a noun or a noun and one or more adjectives modifying the noun. As discussed above, in another embodiment, the item descriptors include trademarks of products and services.

In one embodiment, the item descriptors are made up of letters, numbers and/or symbols. In another embodiment, the item descriptors are composed of only of letters and/or numbers, without any dash, slash, or other (non-alphanumeric) symbols. This further allows the user's Internet search to be more intuitive. In another embodiment, the item descriptors may include spaces (e.g., “cell phone battery” or “cellphone battery”); in still another embodiment, the item descriptors include no spaces (e.g., “cellphonebattery”).

In another embodiment, the item descriptor includes symptom to which a product is associated, rather than the product itself. Thus, in one alternative, exemplary embodiment, the family of item descriptors includes not only the word “aspirin”, but also the word “headache,” which would also be accepted and routed to the Web page for aspirin.

In another alternative embodiment, there are over 10,000 item descriptors/key words utilized by the system 20, making the family of key words even more diverse. The more diverse the family of descriptors/key words is, the greater the likelihood is that a user will be able to obtain the item of interest simply by entering onto the command line of a browser what she wants. Thus, an ideal system would utilize hundreds of thousands (or perhaps millions) of key words across a wide range of industries.

The item descriptors associated with web sites relate to specific products in a diverse range of industries and product lines. A formally designated “Category” may correspond generally to an industry. Further each of the “Subcategories” may correspond to a subgroup within an industry. Just as a variety of “Subcategories” may correspond to a particular “Category”, a variety of key words may correspond to a particular “Subcategory.”

In one embodiment, the key words of the system 20 are associated with Web pages, and a Web page link is provided to the user. In some cases, the system 20 may also look to the “Subcategory” to locate the associated Web page and then provide the appropriate Web page link.

For example, in one alternative embodiment, the family of “Categories” used by the system 20 covers at least two different industries. In another exemplary, alternative embodiment, the family of item descriptors/categories includes products/services in a majority of the industries and product lines listed above.

For example, in another alternative embodiment, the entry words only relate to one industry, but do cover the products/services of more than one competitor in the industry. For example, in still another alternative embodiment, there are at least 100 key words (and associated Web addresses) in any one industry/product line. In another alternative embodiment, there are at least 500 key words in each industry.

b. Common Extension

When using the system 20, in addition to entering an item descriptor, the user may enter a common extension or. alternatively, the common extension (and any other necessary extensions) may be added to the item descriptor automatically by a computer. In one preferred embodiment, the extension is a suffix-type extension following the item descriptor. While not the only place for the common extension, a suffix-type extension is a more preferred embodiment, since it is generally more intuitive for the user: she simply need enter what she wants, followed by the common extension, such as, for example, “.sales7” or “sales7”. In an alternative embodiment, the extension is a prefix-type extension, preceding the item descriptor. Thus, the extension may be on one end or the other of the item descriptor.

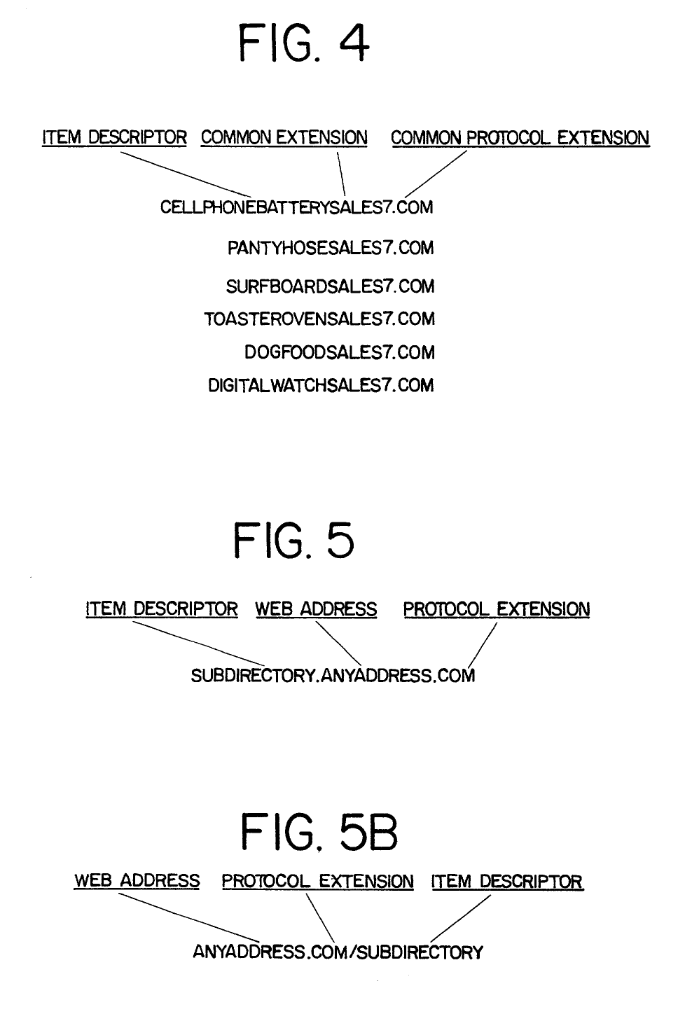

In one preferred embodiments shown in FIGS. 2-14, the term “.sales7” is used as the common extension. Thus, a purchaser seeking to buy a fax machine would enter the following site name onto the command line: “faxmachine.sales7.com”; a purchaser seeking to buy a television would enter the following site name onto the command line: “television.sales7.com“

As shown in FIGS. 2-5 in various embodiments, the item descriptor/browser command entered by a user may (or may not) include, e.g., a period preceding the Web address. In still another embodiment, the item descriptor (and a forward slash) may follow the protocol extension. See FIG. 5B. These and other directory methodologies, which may exist now or in the future, should be considered within the spirit of the system 20.

Numerous other extensions could, of course, also be used in addition to “.sales7” or “sales 7”, such as, for example, “.purchase”, “purchase”, .n36 or “n36.” Thus, with such exemplary alternative embodiments of the common extension, a purchaser might enter: “faxmachine.purchase”, “faxmachinepurchase” “faxmachine.n36.” or “faxmachinen36.”

Examples of prefix-type common extensions might include “get”, “want” or “need.” Thus, with other, alternative embodiments of the common extension, a purchaser might enter, for example: “getfaxmachine.com”, “wantfaxmachine.com”, or “.findproductandservices.com”

Finally, with the system 20, the user enters a protocol extension such that the browser will understand the request. As previously discussed, a fall domain address often includes the protocol extension “http://” as well as a protocol (top level domain) extension, such as “.com” or “.org”.

In yet another embodiment, the consumer need not even enter some or all of the extensions, such as “http://” or “.com”. Rather, the browser, an application on the user's device, or the device itself, may automatically enter all necessary extensions. FIGS. 2 and 3 demonstrate, on different types of browsers, progressively shorter entries that a user may enter on the command/address line, depending on the capabilities of the browser or Internet device. In the case of a browser such as that associated with FIGS. 2D, 2H, 3D and 3H, to implement the system 20, the consumer would need only enter the item descriptor and common extension, as shown in the command/address lines. In another embodiment, a computer, such as the user's computer or the server 28, adds the common extension for the user, such that the user need only input an item descriptor.

In still another embodiment, the user's computer (which may be, as discussed above, a PDA, cellular telephone or other user device interconnected to the Internet), includes a separate, mechanical button 56 (or, alternatively, the user device includes software that functions as such a button). The button 56 (either mechanical or software) adds the common extension, “sales7” (and, if necessary, extension(s) such as “.com”) for the user, thus reducing the actions required of the user to enter a browser command/address.

In one preferred embodiment, the system 20 provides a method for selling products, services or information. Thus, the organizations associated with the servers 26 would be commercial and represented by the “.com” extension. Of course, other commercial or non-commercial protocol extensions may be used with the system 20.

In another example of an alternative embodiment, the organization controlling the system 20 has purchased not only the Web addresses corresponding to the diverse family of item descriptors, but also additional Web addresses that are not ever to be used by the controlling organization. Such Web addresses may include, for example, such terms as sex, adult, skin, porno, XXX, or escort services. In this way, there is a reduced risk that a third party might erect a Web site for, e.g., sexsales7.com, in order to confuse computer users into believing that such a site is operated by the same organization that oversees the system 20. The system 20 may utilize different Web pages and/or sites that correspond to the various addresses reserved by the controlling organization.

c. Operation of the System 20 with Item Descriptors

In accordance with one embodiment of the system 20, in order to go to a Web page that sells cell phone batteries, a potential purchaser (user) need only type, in the command/address line of a browser, the item descriptor, “cellphonebattery” and, if not added by a computer, a common extension, such as “.sales7”, and a protocol extension, such as “.com”: “cellphonebattery.sales7.com”. Upon entering this command, an appropriate Web page would appear on the user's computer 24.

Establishing the system 20 requires controlling organization to make a substantial investment. If the controlling organization utilizes a “non-dot” common extension format for users (such as, e.g., “[item descriptor]sales7.com”), the controlling organization must register and maintain a large number of different Web addresses. If the controlling organization uses a “dot” common extension format for users (such as, e.g., “[item descriptor].sales7.com”), only a single Web address needs to be maintained. However, in both embodiments, the controlling organization must also undertake the substantial expense and effort to identify the particular Web pages hosted by third parties that show items of interest and then organize and align such pages with the item descriptors likely to be employed by the computer users. Once implemented, however, the system 20 benefits the user by allowing purchasers to use an easier and more intuitive method to find items of interest more promptly on a computer network such as the Internet.

Such organization and alignment of pages on the Internet may be accomplished by compiling the substantial list of item descriptors that a user is likely to use, organizing them, and then associating them with the most appropriate Web pages.

d. Organization of Item Descriptors

The item descriptors may generally be organized into the following groups:

“Entry Words” (including “Entry Word Sets” and derivations of an Entry Words used by the system 20);

“Key Words” (which includes “Key Word Sets”); and

“Categories” (which includes “Subcategories”).

The term, “item”, refers to a resource available through a network, such as the Internet. An “entry word” is the word (or group of words) actually entered by a user to designate an item or which are derived by the system 20 from the actual word(s) entered by a user. The term, “item descriptor”, generally refers to a designation of a item, including a entry word input by a user and other words used by the system 20 (including key words and categories) to locate the item desired by a user. A key word is a term recognized by the system as an item of possible interest to users.

Different entry words that are treated as substantially synonymous by the system 20 comprise a “entry word set”. Key words that are treated as substantially synonymous by the system 20 comprise a “key word set”. Of course, the terms, “item descriptor“entry word” and “key word” can each refer to both a single word and to a plurality of words.

Categories are major divisions of items or products that a user may request, and subcategories are more specific divisions of such items. The term, “category” can be construed to include both categories and subcategories. Typically, specific subcategories are associated with specific Web site pages.

Thus, the system 20 includes:

(1) a family of key words that is both large (e.g., over 10,000 entries) and diverse, such that such key words are more likely to correspond to entry words (either as entered by a user or as interpreted by the system 20); and

(2) a pre-established set of relationships, or associations, (1) between key words and subcategories, and (2) between subcategories and Web pages. The system 20 is thus able to promptly retrieve for a user a specific Web page responsive to an entry word because of the system's pre-established relationships, or associations, between key words and selected Web pages. One exemplary, but certainly not exclusive, way for the system 20 to maintain such relationships, or associations, is in a software-based “look-up” table.

The specific Web pages provided to a user are often hosted and operated by third parties rather than the controlling organization that oversees operation of the system 20. Further, such pages may typically be below (an often well below) the home page of the third party Web site host.

An entry word may or may not correspond to a category of items or products. A user might, for example, enter, “jewelry”, “gewelry” (phonetic misspelling), “newelry” (mistyped “n” for “j”), “jewelries” (plural form). The entry word, “jewelry”, is recognized by the system 20 as a key word. Thus, upon receiving the entry word, “jewelry”, the JES would locate the word, “jewelry”, in a table that identifies it as a key word.

When the entry words are not key words, the IES, as described below, determines a key word that is likely to correspond to the entry word and provides this key word as the interpreted request. The IES thus helps fulfill the objective of increasing the probability of successfully presenting the user with the item requested in less time with a fewer number of keystrokes.

When the interpreted request is a term, such as “hose”, that may interpreted in different ways, the system 20 will prompt the user for additional information prior to issuing a interpreted request to the rest of the system 20: E.g., “Do you want garden hoses (housewares), automotive hoses (automotive parts) or hosiery (clothing)?” When the user makes such a selection (or, if no such selection was necessary because the category was unambiguous), the system 20 may then present the user with one of two different options.

In one exemplary embodiment, the user is asked to select a retailer. Upon doing so, the user is next presented with “deep-linked” page from the retailer that shows the item of interest or a selection of variations of the item of interest (e.g., different makes, models and brands).

In another exemplary embodiment, the user need not be asked to choose a retailer. In such cases, the user is “deep-linked” to a specific page(s) from a retailer Web site(s) that shows the item of interest without the need for selecting the retailer first.

In either case, however, the user promptly is presented with the deep-linked page of the third-party hosting entity. There is little need for the user to navigate the Internet nor a particular retailer's often-complex Web site. Thus, the system makes finding and purchasing items over the Internet substantially easier and faster, and eliminates the need for users to learn each different Web site's navigation and search methodology.

The possible entry words, “gewelry”, “newelry”, “jewelries”, are not key words of the system 20. Nonetheless, the IES will accept such terms and determine a likely corresponding key word utilized by the system (“jewelry”). Utilizing this input, the system may, in one embodiment, request that the user select among retailers, and then provide a direct lick to a specific page relating to the key word, “jewelry”.

A user might have, instead, entered more specific item descriptors such as “jems” (phonetic mis-spelling), “gems” (singular) and “gem stones” (plural). The IES interprets “jems” to mean the key word, “gems.” The two key words, “gems” and “gem stones”, generally might have the same meaning to most users and, thus, when entered by a user, lead a user to the same Web page. Thus, the item descriptors, “gems” and “gem stones” belong to a keyword set. Upon entering, “jems”, the IES interprets this as an entry word corresponding to the key word set for “gemstones,” which, in turn, corresponds to the subcategory, “jewelry-gemstones” (under the category, “jewelry”). Upon choosing a retailer, the user is deep linked to a Web page offering gemstones for sale.

Upon receiving the entry word, “semi precious j ems”, the IES interprets the input as an entry word corresponding to the key word, “semi precious gems.” Upon choosing a retailer, the user is deep linked to a Web page offering semiprecious gemstones for sale.

Upon receiving the entry word, “garnets”, the JES interprets the input as corresponding to the subcategory, “jewelry-gems-semi precious”. Upon choosing a retailer, the user is again deep linked to a Web page offering garnets for sale. The user is provided with a page designating the industry/category and subcategory to confirm to the user what is being shown (e.g., jewelry -jewelry-gemstones-semiprecious). Notably, with the use of dashes or hyphens, the system need only employ a two-tiered category, easing the controlling organization's administrative burden.

In all of the above examples, the user is generally not directed to the home page of a jewelry store or other retailer, such that the user must check lists on the home page or operate a search engine to find the item of interest. Rather, the controlling organization has determined, in advance of the user's request, key words that are likely to correspond to the user's request and pre-associated them with the category and Web page.

2. Deep-Link Pages

While many prior systems use software “search engines” to provide lists to users of possibly relevant Web sites, the controlling organization has previously matched thousands or tens of thousands of possible requests with the appropriate page for prompt action (e.g., the ability to purchase the designated item rather than, for example, a Web site home page that may have the desired pages “deep” within the site or a Web site that does not offer items for sale).

The system 20 may be considered a “smart” search resource to help users more quickly and easily locate items on the Internet. In contrast to the conventional wisdom that improved software programs are needed to do more elaborate searching on the Internet, applicants have, in some respects, taken the opposite approach. The controlling organization has found the responsive pages ahead of time (typically manually) and associated them with likely search terms (typically manually). As discussed above, Applicants have discovered that careful preparation for user requests ahead of time, rather than the development of advanced, software-based search engines, often provides superior results.

Rather than linking users to, general home pages or pages that may be only tangentially related to the requested item, the system 20 has pre-selected (typically selected manually rather than with an automatic search tool) specific pages and associated them with the item descriptors. In effect, the controlling organization has prepared for searches by doing the navigation and drilling ahead of time, so that the user does not need to. The search results are then associated with likely search terms, though both organization of key words and the interpretive entry system, so that, in large measure, the user tend to see, with a reduced number of clicks and wasted time, the item that she requested.

Such referral to deep-linked pages, of course, may result in increase revenues to the third-party hosting entity to which the user is referred. In one (but not necessarily exclusive) preferred embodiment, the referral is made even where there is not a referral or fee splitting arrangement between the controlling organization and the third-party hosting entity. References to the Web pages of third parties who do not want such referrals may, of course, simply be deleted from the system 20 by the controlling organization.

Prior systems may refer a user to a third party's Web site only if there was a pre-existing contractual relationship between the referring entity and the third party to which the user is referred. Often, such a referral did not occur absent an agreement that the referring entity would be given a “referral” or “associate” fee by the third party. In one embodiment of the present system 20, however, the research and referral may take place at the expense of the controlling organization, without the need for such contacts and agreements for revenue sharing. In this way, the user is more assured of promptly finding the item that she wants (and not simply items that are offered by firms that have a contractual relationship with the referring company).

Even after a deep-linked Web page which corresponds to a key word is located (e.g., a page within the Web site of a jewelry store that relates to precious gems), the page still may not necessarily qualify for linkage to a key word in the system 20. In one preferred, exemplary embodiment for finding items for sale over the Internet, if the page does not actually offer the item for sale, the page is excluded from the system 20. Further, even if the third-party host of the site does offer items of interest for sale over the Internet, the controlling organization may also deem that the site is unqualified and choose to avoid including such third-party site in the system 20. Thus, the controlling organization may exclude a site if, for example: the third-party has a bad or uncertain reputation for customer satisfaction; the product appears to be season and the season has passed; the product is a short-term sale item or is otherwise an offering that is likely to expire in the near future.

Further, some deep-link pages may employ Session Identification (SID) codes or engine identification codes. In effect, such pages have transitory addresses, such that the address of the deep-link page is not stable over time. Again, in such a case, the address generally may not necessarily be associated with a key word and utilized by the system 20.

2. Interpretive Entry System (“IES”)

a. Generally

The system 20 increases the probability of successful search user. Part of this success stems from the system's ability to interpret what the user has input. The IES is useful when a user inputs information with a keyboard, but also with other input devices, such as, for example, a speech recognition program.

Many high school graduates in the United States may have a spoken vocabulary of 10,000 English language words or more. Some of the graduates, however, may spell proficiently only a fraction (e.g., one-quarter) of such a total. The IES in the system 20, however, accommodates incorrect inputs. The accommodation is accomplished with a variety of techniques for better understanding, or interpreting, what the user wants. As discussed below, variations of the entry word are developed by the IES and then provided to the rest of the system 20 so that it may search for a key word that corresponds to the variations.

All or only some of the following IES techniques may be used by the system 20. Each of the IES techniques may be used alone or in combination with one or more of the other techniques. The variations may be found in a predetermined “look up” table or be processed “on the fly” by a computer.

The IES variations may be developed for each word in the entry word input by the user and added to the list of search terms. Much of the IES activity may be conducted automatically with a computer, rather than manually.

Thus, in operation, a user may make a request for an item using a variety of different formats. In one embodiment, a small program (such as, for example, an applet) resides on the user's computer. Upon activating the small program (such as “clicking”) an icon associated with the small program, the small program generates a search box, such as that shown in FIG. 39. A search box should be understood to be any type of computer inquiry that allows a computer user to enter a request for an item of interest.

Thus, for example, the user may enter the request in such a search box generated by a small program on the user's computer, or on the command line of a web browser, or in the search box on the web site for a web retailer. In the first example, the small program can be downloaded to the user's computer via an Internet download or a directly distributed computer disk. In the first two instances listed, the user's browser may be launched. In all three examples, however, upon entering the name of the item requested, the system determines a pre-established association between the user's request and a particular Web page pertaining to the request.

In one preferred embodiment, upon entering a search term, the user is directed only to the web site of a preferred vendor. In another embodiment, the user is directed to the page (or pages) of one or more of vendor chosen from a group of preferred vendors. In still another embodiment, the user is provided to the site or sites of interest, where particular vendors are not given preference.

In one variation of the system, a request by the user in the year 2001 consisting of www.gladiator.zzzretailer.com, http ://gladiator.zzzretailer.com or http://www.gladiator.zzzretailer.com” would all lead the user to the same web page of the specific retailer identified (here exemplified by the name, “zzzretailer”). That page would have available the item most likely desired: e.g., a videotape of the movie, “Gladiator.” A user entering the request, “gladiator,” in the search box on the web site of the retailer would similarly lead the user to the same page of the retailer's store.

The IES thus promotes the business purpose of converting casual shoppers into actual customers of the retailer by providing a prompt method for users to find what they are looking for. Users can thus devote their time and energy to selecting models and entering payment information, rather than to searching for the item of interest.

The IES may work from the retailer's server(s) and integrate with the controlling organization's system to provide a virtually invisible front end to the retailer's web presence without the cost of redesigning (and possibly confusing) existing customers. The IES generally seeks to follow the natural thought-process of the user, reducing the number of decisions and actions need for the user to find items. The increasing speed of finding items results in less user confusion, search result consistency, more transactions, happier customers and, generally, better business results.

b. IES Techniques

1. Parse Input Data

Upon receiving a request (user keyword input) from, for example, either a small program, browser command line or web site search box, the IES system parses the input data to select the words or words most likely to contain the name of the requested item. In, for example, the requests, www.gladiator and “I want gladiator,” the “www” and “I want” can be deleted from further IES processing.

2. Phonetic Processing and Spelling Correction

Some users may input an entry word that corresponds to how an items is often pronounced, rather than how the term is spelled in a dictionary: E.g., “azma relief” rather than “asthma relief”; “tellavision” rather than “television”. Accordingly, the IES includes a table of phonetic spellings of possible entry words. The IES also creates new possible entry words by, for example, changing a “v” with a “ph” and visa versa and changing “all” to “awl” and visa versa.

The phonetic spellings are associated with a more standard spelling of the term (as an entry word group). The entry word group is associated with a key word, which, in turn, is associated with a category or sub-category. In one exemplary embodiment, the category or subcategory is associated with a list of retailers, which is then presented to the user. Upon receiving the user's choice of retailers, the system presents an appropriate page (typically a deep-drill page) to the user.

Alternatively, of course, a third-party “plug-in” software module could be used with the IES for phonetic processing and spelling correction.

3. Generalized IES Processing

a. Synonym Analysis/Processing

A user may enter her request for an item in a variety of different format. The IES system keeps a predetermined listing of likely synonyms and, upon finding a match, refers the user to the appropriate web page. Thus, for example, a user seeking to purchase a 17-inch computer monitor might type in any of the following descriptors: all of them result in the user receiving a display of the appropriate page showing 17-inch computer monitors.

17″ Monitor

17 Inch Monitor

17 Monitor

Seventeen Monitor

Seventeen Inch Monitor

17″ Computer Monitor

17 Inch Computer Monitor

17 Computer Monitor

Seventeen Computer Monitor

Seventeen Inch Computer Monitor

17″ PC Monitor

17 Inch PC Monitor

17 PC Monitor

Seventeen PC Monitor

Seventeen Inch PC Monitor

17″ Screen

17 Inch Screen

17 Screen

Seventeen Inch Screen

Seventeen Screen

17″ Computer Screen

17 Inch Computer Screen

17 Computer Screen

Seventeen Computer Screen

Seventeen Inch Computer Screen

17″ PC Screen

17 Inch PC Screen

17 PC Screen

Seventeen PC Screen

Seventeen Inch PC Screen

b. Space Analysis/Processing—Multiple Word Processing—Punctuation

Many users are unsure whether to include spaces in commands. Internet addresses, for example, generally do not include spaces, and Internet-users often come to learn this. Accordingly, users often tend to omit spaces in search boxes out of habit. The IES accepts no-space queries for items and delivers to the user the proper pages. This no-space processing can perform an analysis to find a corresponding key word for which the spaces between words have also been deleted. Alternatively, the no-space analysis can include inserting spaces into or deleting spaces from the inquiry word as the system looks for a match between the entered term and a key word. Thus, for example, each of the following descriptors without spaces shown on the left below is recognized as the descriptor on the right, so that the user may, again, be directed to the proper page.

Exemplary Descriptors Corresponding Key Words

tinaturner→tina turner→Tina Turner Audio Compact Disks

bigscreentv→big screen tv→Big Screen Televisions

colorprinter→color printer→Color Printers for Computers

3commodems→3Com modems→3Com Brand Modems for Computers

portablecdplayer→portable ed player→Portable Compact Disk Player

michaeljackson→michael jackson→Michael Jackson Audio Compact Disks

stereospeakers→stereo speakers→Stereo Speakers

panasonicdvds→panasonic dvds→Panasonic Digital Video Disks

aperfectstorm→a perfect storm→A Book entitled “A Perfect Storm”

faxmachine→fax machine→Facsimile Machine

cordlessphones→cordless phones→Cordless Telephones

sonycamcorders→sony camcorders→Sony Camcorder

laptopmemory→laptop memory→Laptop Computer Memory Chips

tina turner twenty four seven→Audio Compact Disk entitled “Twenty Four Seven” by the vocalist, Tina Turner

tinaturnertwentyfourseven→Audio Compact Disk entitled “Twenty Four Seven” by the vocalist, Tina Turner

tinaturner247→Audio Compact Disk entitled “Twenty Four Seven” by the vocalist, Tina Turner

a perfect storm soundtrack→Audio Compact Disk of the soundtrack of the movie, “A Perfect Storm.”

aperfectstormsoundtrack→Audio Compact Disk of the soundtrack of the movie, “A Perfect Storm.”

Jvc mini dv camcorders→Mini Digital Video Disk Camcorders manufactured by JVC

Jvcminidvcamcorders→Mini Digital Video Disk Camcorders manufactured by JVC

Spaces are a part of most written, English-language communications. Thus, for all permutations, the IES may generate additional terms by removing all spaces and/or adding spaces before and/or after any terms that are recognized as whole words. The IES may develop further variations by removing symbols that are not letters or numbers, such as, for example: commas, per i ods, apostrophes, ampersands, currency signs question marks, percent signs, slashes, backslashes, pound signs, quotation marks, asterisks, parentheses, brackets algebraic fuinctions signs, colons, semicolons, at (“@”) signs, hyphens, and dashes.

c. Slang Analysis/Interpretation

Some users may input an entry word that corresponds to how an item is often refer to colloquially, rather than how the name is spelled in a retail catalog: E.g., “TV” rather than “television”; “fax” for “facsimile machine”; “copier” for “photocopy machine”. Accordingly, the IES includes a table of slang terms and abbreviations (and, in one embodiment, the misspelling of such slang terms).

The slang terms and abbreviations are associated with a more standard spelling of the term (as an entry word group) in a standard language, such as English. The entry word group is associated with a key word, which, in turn, is associated with a subcategory of items. In one exemplary embodiment, the subcategory is associated with a list of retailers, which is then presented to the user. Upon receiving the user's choice of retailers, the system presents an appropriate page to the user.

d. Continuity Analysis/Maintenance

For example, any entry from the synonymous product set of Monitor, PC Monitor, Computer Monitor and Desktop Monitor displays the identical web page. Or, in another example, any entry from the synonymous product set of PDA, Hand Held, Hand Held Computer and Personal Digital Assistant displays the identical web page. Synonymous listings all means the exact same thing and must display the exact same results to eliminate shopper confusion. Web sites commonly display different search results for synonymous inputs which may confuse the users. The IES helps correct this problem.

e. Trend Analysis

Previously, web search results were often displayed in a haphazard way. An optional IES system module prioritizies top product by current purchasing trends, to more likely produce a page directed to the item of interest. For example, a search for the new “Gladiator” movie appears low in the ranking. This is odd due to the current trend basis and the hug success of the 2000 hit movie by director Ridley Scott.

The IES system would place this movie first in the search results, but, for the few instances that this was not the desired product of the shopper, an optional search button would be displayed for default site-wide selections.

f. Forced/Common Misspellings

Some users may simply misspell an entry word: E.g., “vacume” rather than vacuum”; “asfault” rather than “asphalt”; “wafle” rather than “waffle”. Accordingly, the IES includes a table of possible misspellings of entry words. The misspelled terms are associated with a more standard spelling of the term (as an entry word group). The entry word group is associated with a key word, which, in turn, is associated with a subcategory. Upon, e.g., receiving the user's choice of retailers, the system presents an appropriate page (typically a deep-drill page) to the user

The IES also develops natural or non-U.S. variations of entry words, such as “crème” for “cream”, “center” for “centre” and “theater” for “theatre”. Further possible entry words are developed by omitting the second letter (such as “bseball” for “baseball”), omitting the second-to-last letter (such as “computr” for “computer”); inverting the last two letters (“waffel” for “waffle”; and leaving out the “i” in a word ending with “Ing” (“wedng” for “wedding”).

Alternatively, of course, a third-party “plug-in” software module could be used with the IES for phonetic processing and spelling correction.

4. Plural and Singular Forms

Users may not know whether their item descriptor should be expressed in the singular or plural form. Accordingly, in one exemplary embodiment, all singular entry words are automatically re-written and, of course, added by the IES in a plural form. In another exemplary embodiment, all plural entry words are re-written and, of course, added, by the IES in singular form. For such terms thus newly created by the IES, the system 20 also searches for a key word corresponding for the newly formed entry word as well. Thus, for example, IES rules for creating plural and singular forms of English language entry terms may include:

Add “s” and es” to all words not already ending in “s”.

If the entry word ends in “ies”, remove “ies” and add “y”.

If the entry word ends in “ies”, remove the “s”.

If the entry word ends in “y”, remove “y” and adds “ies”.

If the entry word ends in “es”, remove “es”.

If the entry word ends in “es”, remove the “s”.

Create plurals and singular versions of entry words where a plurality is not necessarily expressed with a final “s” (E.g., “goose” and “geese”; “child” and “children”; “man” and “men”).

5. Repeated Letters

If the entry word includes two adjacent letters that are the same, the IES may remove one of the repeated letters. If the entry word includes more than one instance of two adjacent letters that are the same, the IES may remove one of the repeated letters, then remove a different one of the repeated letters, continuing this process until all permutations of single and double letters have been formed. Of course, the system 20 also searches for a key word corresponding to each of the terms so created by the IES as well.

6. Numeric Variations

Entry words with numbers should be expressed in at least three different ways: as words (e.g., “six”), numerals (“6”) and Roman numerals (“VI”). Prior to a search, users often must know a given product's exact numerical designation (words, numerals or Roman numerals). For example, a consumer searching for a “Palm V” personal digital assistant may not easily reach a correct page upon entering the search request, “Palm5.” IES helps solve this problem.

7. “Thick Finger” Analysis

Some users may misspell an entry word, not because of a lack of spelling skills, but because of a simple input error. If the inputs are being made with a keyboard, for example, the user may simply make a keystroke, or typographical, error: the user's finger simply hits the wrong key. The IES thus implicit assumes that the user's finger physically came close to the intended letter, but the intended key was missed.

Thus, if an entry word is not promptly recognized, the IES may try substituting likely mistaken letters. If, for example, the user is employing a keyboard with a standard, English-language QWERTY layout, and the letter “j” was input by mistake, the most likely intended (correct) is the one whose key is physically adjacent, or at least close, to the letter “j” on the keyboard: the letters k, m, n, h, u, and i. Similarly, if the letter “z” was input by mistake, the most likely intended (correct) letter is the one whose key is physically within the cluster of keys around the letter “z” on the keyboard: the letters a, s and x. The IES may simply begin substituting “close” letters for entered letters (e.g., the letters “a, s, and x” for the letter “z”) and check whether any such newly developed entry words correspond to a key word.

8. Foreign-Language Interpretation

Much of the Internet content is provided in the English language. (Thus, at present, English may be considered a “standard” language for Internet usage.) Computer users who are not fluent in printed English frequently encounter greater difficulty in locating all of the relevant resources of the Internet. Thus, in one embodiment, the IES accepts from the user an entry word in a first (e.g., non-English) language.

The non-English language entry word may be subjected to one or more of the techniques described in this section. Thereafter, the IES correlates the word entered by the user with an accepted non-English language word (e.g., the German-language entry word, “Edelstein”, may be developed from the incorrectly spelled German-language word “Edelstien”). The IES then translates the non-English language word into English and advises the rest of the system 20 that the entry word is the corresponding Englishlanguage entry word (e.g., “gem”). Thereafter, the system 20 determines the associated key word, category and Web site as though the user had entered the English-language word (“gem”) rather than a non-English-language word.

9. Spell Checking and Correction Programs

Spell checking and correction programs are conventional and commonly used in, for example, many word-processing programs. Such programs may, for example, employ lists of words and attempt to make judgments on which is the closet match of the term actually input and a list of accepted words. Such programs may also employ basic spelling rules such as, for example, the letter u should follow the letter q; the letter, I, generally precedes the letter→(except after the letter c or in notable exceptions such as “neighbor”, “weigh”, or “weird”. To the extent that no match can be found to a key word, the IES may simply display, for example, a pull down menu with a list of alternative possibilities, asking the user to highlight and select one.

Alternative Distributed System

As described herein, one exemplary embodiment of the system 20 utilizes a network and programs resident on servers ran by the controlling entity. In other, alternative implementations, of course, all or portions of the system 20 may also be resident on other computers, such as the user's computer. For example, as the abilities of computer hardware and software improve, the processes of interpreting a entry word, associating an entry words with a key word, determining a pre-established association between a key word and a category, and determining a pre-established association between a category and an item, and linking to specific, deep-link page may be carried out on the user's computer (or, in whole or in part, at a location remote from that of the controlling organization). Thus, rather than the embodiment shown, the system might also be implemented with a distributed software system or with programs loaded onto users' computers.

User Experience

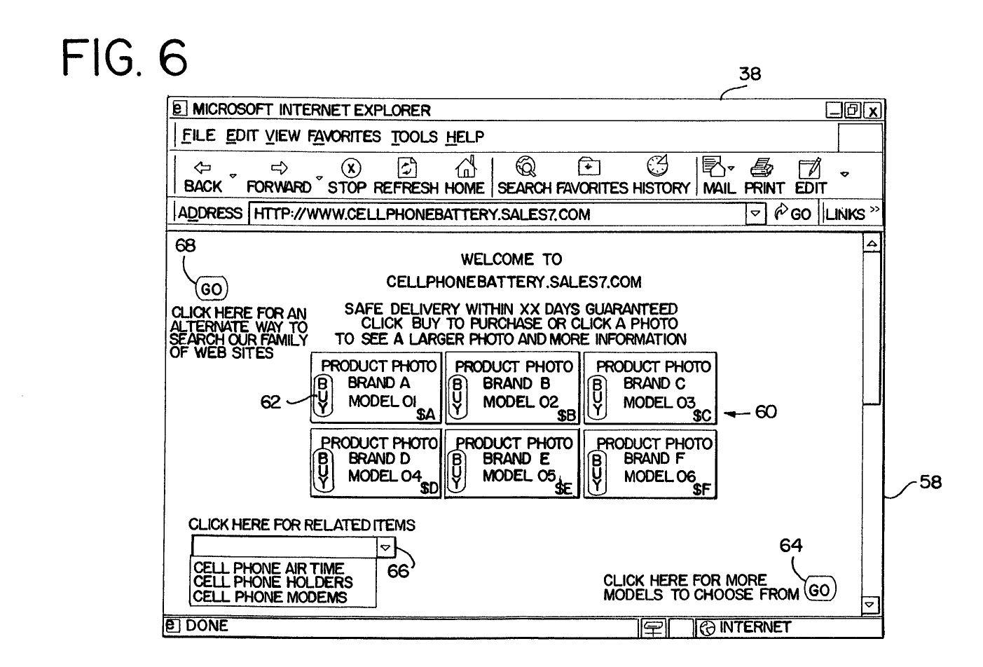

An exemplary, main, initial page 58 is shown in FIG. 6. Upon reaching the initial page of FIG. 6, the user may view one or more primary items. In the particular example of FIG. 6, a plurality of primary items (or other designations) 60 are shown. Each of the items may have associated with it such information as manufacturer, model and price. Additional items of interest may be available, but are not shown on the initial page 58. The display of six primary items, rather than another number of items, is only exemplary.

As shown in FIG. 6, the preferred items 60 have associated with them buy buttons 62. According to one embodiment, a purchaser may place an order by a single action upon reviewing the initial page 58. Thus, for example, by simply placing a cursor over the appropriate buy button 62 and clicking a mouse button, the user may order the item.

In alternative implementations, further information is available to the user viewing the Web page of FIG. 6. If the user wishes to obtain additional information regarding the primary item(s), or wishes to see a comparison of the primary items or, in yet another embodiment, wishes to make selections as to the attributes of the products or services (such as color, size, time of delivery, payment method, etc.), the user may also activate one of the icons for the items 60. The user may also view additional items by activating the button 64, link to another site of the system that sells related products and services by activating the button 66, or go to a system search page by activating the button 68.

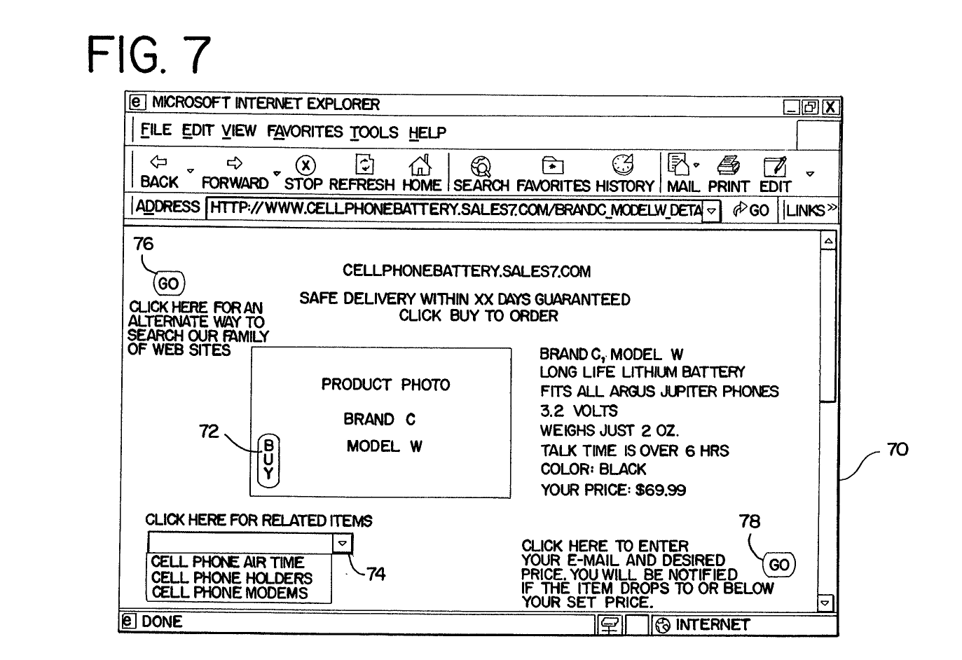

Upon activating one of the icons for the items 60, the user is then shown additional information, such as that in the exemplary Web page 70 of FIG. 7. After viewing the additional information or making choices regarding the attributes of the product, the user may place an order for the item or otherwise place the item in an electronic “shopping cart” by activating the buy button 72. Again, the user may obtain information on related items, move to the system help site, or instruct the system 20 to notify the user if the price of the item shown drops to or below a price set by the user. This is accomplished by activating, respectively, the buttons 74, 76 or 78.

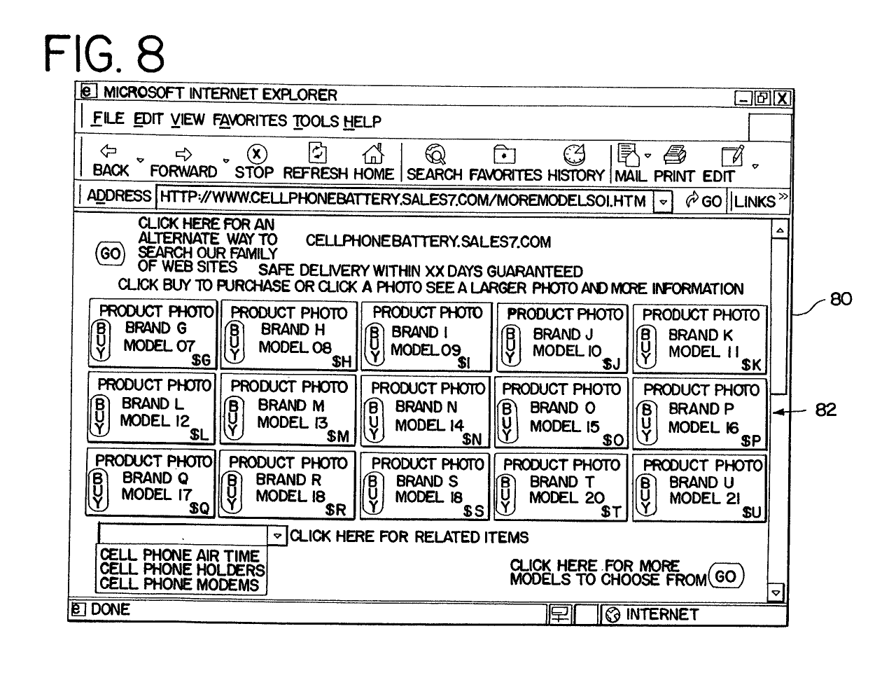

Upon activating the button 64 shown on the Web initial page 58 of FIG. 6, the user may view a Web page 80 such as that shown in FIG. 8. The Web page 80 shows images 82 that display information regarding additional products. Again, by activating an electronic button, the user may order one of the additional items, view information on still more items, find out about related items or go to a help site for an alternative way to search the system's family of Web pages.

The button 66 on the initial page 58 may be activated to provide information on related products that may be of interest to users who have reached the initial page 58. Such information may take the form of a drop down menu, such as that shown in FIG. 6. Alternatively, activating the button 66 may result in the user viewing Web pages such as the exemplary Web pages 58, 80.

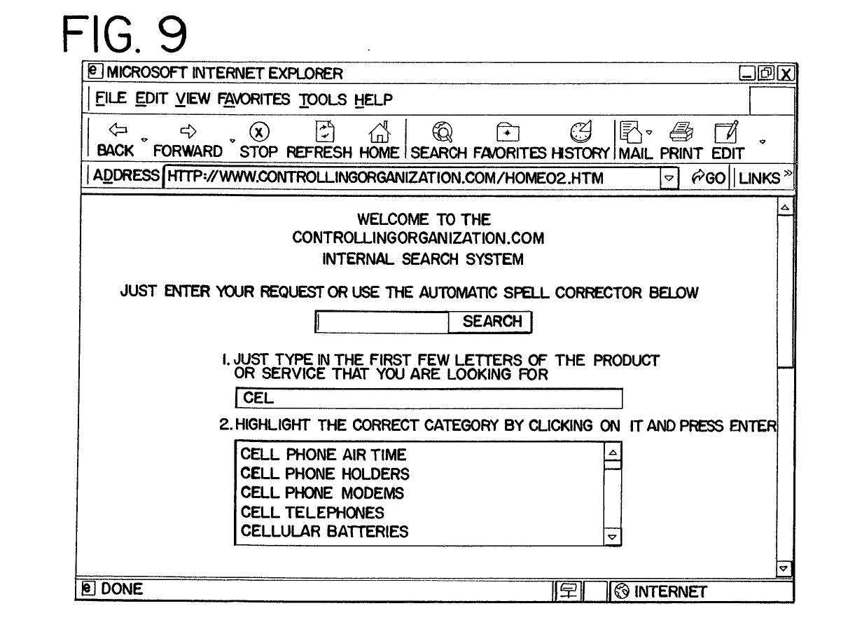

The button 68 on the initial page 58 may be activated to assist the user in finding other Web pages within the system 20. Upon activation, a Web page such as that shown in FIG. 9 results. The user is provided with a pull-down index that provides possible items based upon the letters entered by the user.

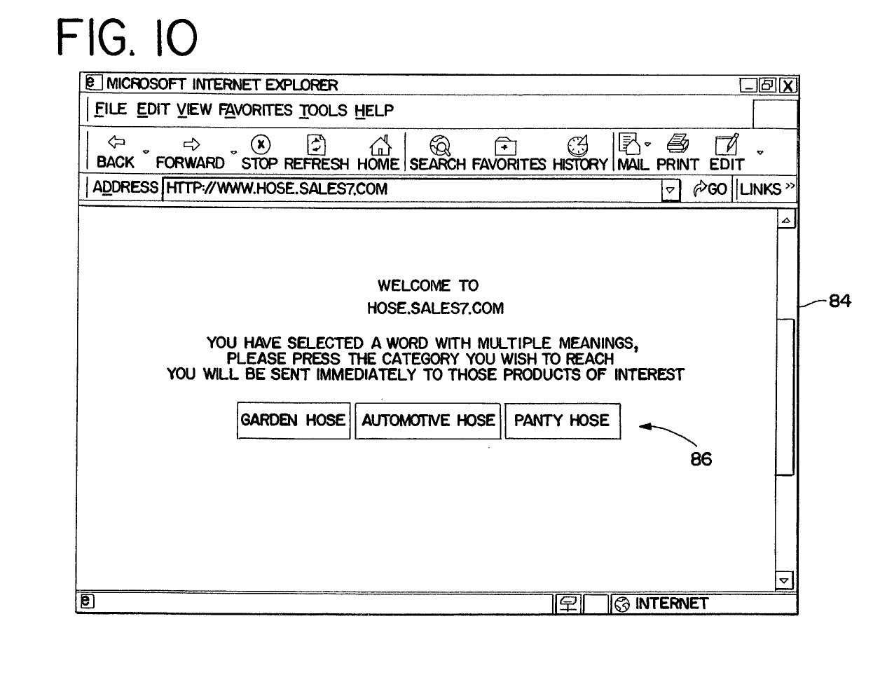

In some instances, providing described items on the initial page 58 may prove cumbersome, since the item descriptor itself may not be adequate to determine the nature of the user's request. If, for example, a user should type in “hosesales7.com”, the user might be seeking either a type of garden product, automobile part or nylon stockings. In such a case, the first initial page may present, after “hosesales7.com” has been entered in a browser command/address line, a screen 84 such as that as shown in FIG. 10 is displayed to the user. The screen displays attribute choices that correspond to electronic buttons 86. The buttons 86 link the user to different system pages, depending on user's preference: e.g., garden hose, automotive hose or panty hose.

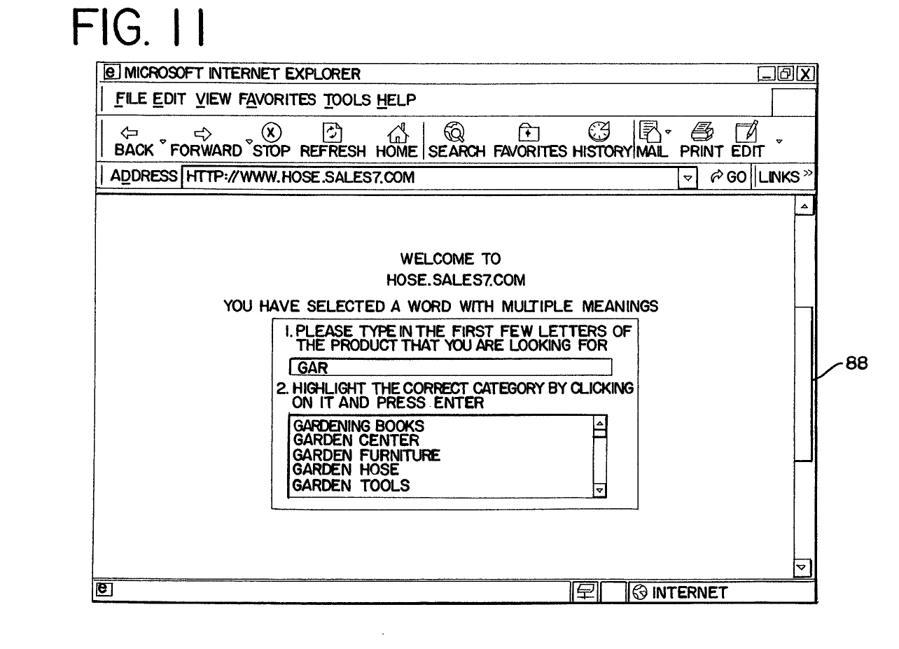

In some cases, there may be a large number of attribute choices. In lieu of the electronic buttons 86 shown in FIG. 10, there may be provided a search window 88, as shown in FIG. 11. The user is instructed to type in the first few letters of the type of hose wanted. The user can type in, for example, “gar” to highlight a description of, and activate a link to an initial page of the system 20 showing, garden hoses.

This type of window can also be used to locate any item in the system 20 without the user needing to return to the command/address line of the browser if she so desires. A separate button for access to this type of window may be provided on some pages, or on every page, displayed to the user by the system 20.

The user's order may be finalized if the server is aware of the identification of the purchaser. Thus, before, during or after the initial page of FIG. 6 is displayed, the user must enter purchaser information. The purchaser information may, for example, take the form of information entered with, for example, a keyboard, password, or other identification (such as a cookie sent by the user's computer to the system server). In response, the system server may then accept the order. The purchaser information typically, but not necessarily, includes such data as the purchaser's name, address, and credit card account information (account number and account expiration date). Other information may also be included in the purchaser information, such as, for example, the address to which a product should be shipped (if different than the purchaser's address) as well as demographic information.

In the most preferred embodiment, the purchaser information is entered after the initial page, such as that shown in FIG. 6, is displayed. In another embodiment, however, the purchaser information is entered before the user arrives at the initial page shown in FIG. 6. A central computer of the organization controlling the system 20, or another system server, may be responsible for debiting the credit card account of a purchaser as well as assembling the collected demographic information.

The system 20 thus allows a computer user to promptly reach the Web page selling the item described. The process is purposefully designed to be more intuitive and reduce the number of “clicks,” or other actions, that a user must make to purchase a particular item of interest.

On many occasions, the initial page showing the item of interest (e.g. as shown in FIG. 6) will be displayed immediately upon entering the item descriptor and common extension onto the command line of a browser. In another alternative embodiment, however, a relatively small number of introductory pages or screens (such as those shown in FIGS. 10 and 11 or those which collect purchaser information) may need to be interposed prior to the user reaching a main initial page such as that shown in FIG. 6. In such an alternative embodiment, the screen 58 of FIG. 6 may still be considered an initial page.

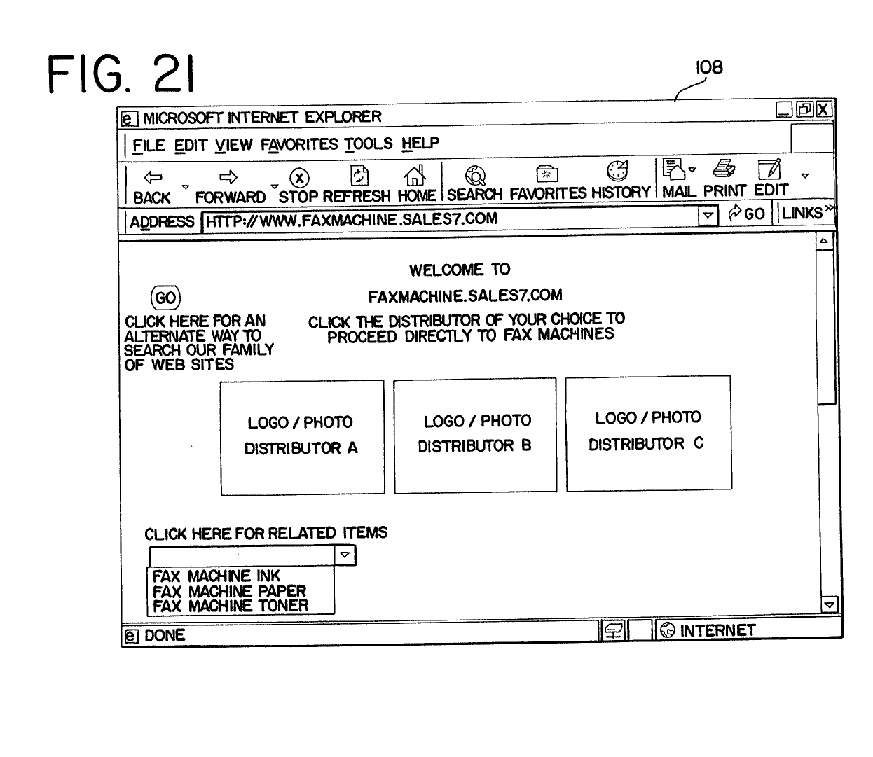

In still another, alternative embodiment, the system 20 displays a page having one or more links to the Web pages of third-party distributors who supply the item of interest to the computer user. Such a display is shown, for example, in FIG. 21. In the alternative preferred embodiment now described, such a page should also be considered an initial page. As before, the initial page of FIG. 21 may be displayed either immediately after a user enters an item descriptor (and common extension and protocol extension(s), if needed), or may be displayed after a relatively small number of introductory pages or screens are displayed. In the most preferred version of this alternative embodiment, the links of FIG. 21, when activated, will cause to be displayed the Web page of the third-party distributor Web site which includes the item of interest to the user.

The system 20 generally makes obtaining items from the Internet simpler and more intuitive. A computer user may obtain a product or service simply by entering what she wants, followed by the common extension, “.sales7”, and the protocol extension, “.com” (both of which may be entered by a computer automatically upon entry of the item descriptor by the user.) After purchasing, or examining, a first product, the user could similarly enter a second item descriptor, the common extension, and, if necessary, a protocol extension, to quickly locate the next item of interest.

The process of finding a site on which to buy a product is intuitive in that it better follows the logic of a consumer: If a consumer wants aspirin, she should start entering the word, aspirin, rather than the name of a local distributor or the manufacturer. Since the family of item descriptors is so large, and generally maintained by one controlling organization, the consumer is likely to find what she wants without needlessly wading through Web sites that are irrelevant to her.

The system 20 delivers the user to the initial screen, such as that shown in FIG. 6, either immediately upon entering the browser command address (item descriptor and common extension) or after a relatively nominal number of introductory initial screens are displayed to the user. Accordingly, the number of actions (such as mouse clicks) that a user must go through in order to locate the item of interest are typically reduced.

With the system 20, there is generally little need to use search tools or review a list of irrelevant search engine responses to find specific products or services. There is a reduced need to download page after page of irrelevant or unprofessional sites. Rather, the Web sites of the system 20 are coordinated by the controlling, or central, organization when the system 20 is established. Consequently, consumers may generally reach an item of interest more quickly, and Web sites of generally offensive subject matters, such as pornography, violence and hate, simply are excluded from the system 20.

Moreover, sensitive or personal items, such as, for example, condoms, tampons and hemorrhoid medicine, may be purchased discretely and easily in confidence without dealing with pornography or needing to know the brand name of any item. The system's Web site may be considered “sticky”: purchasers will be likely to return to the system Web pages upon using them and learning their benefits.

The system 20 helps simplify the process of electronic commerce and navigation for consumers on the Internet. A consumer generally needs only to learn to enter a product descriptor together with an extension (and protocol extension, if necessary) in order to obtain a reliable Web page/site that has the item (e.g., product, service or information) that she wants.

There is no longer a need to remember a large number of Web site names, many of which may have no, or only a cryptic, connection to a particular good or service. The system allows consumers easily to find specific items by using only a browser. In large measure, most consumers may use a method for Internet purchases that is similar to the process they have generally been using in brick and mortar stores: simply enter, or ask for, what you want and then add a common extension.

Minimizing the number of different Web pages that a consumer must wade through in order to accomplish an objective is important in improving the experience of the Internet. The system 20 overcomes many hurdles currently associated with Ecommerce and makes purchases on the Internet easier.

Still Further Optional Features

1. Accommodation of Lower Capability User Devices

The individual Web pages associated with the system 20 may be fairly uncluttered and straightforward, without a substantial amount of text or graphics. The exemplary initial Web page 58 shown in FIG. 6 has limited content and, thus, may be more easily transmitted to, and/or received by, lower-capacity computers, such as, for example, PDAs, cellular telephones, WAP phones and other wired and wireless devices. Such lower-capacity computers have processing power, available memory and/or display capacities below that of a typical desktop computer.

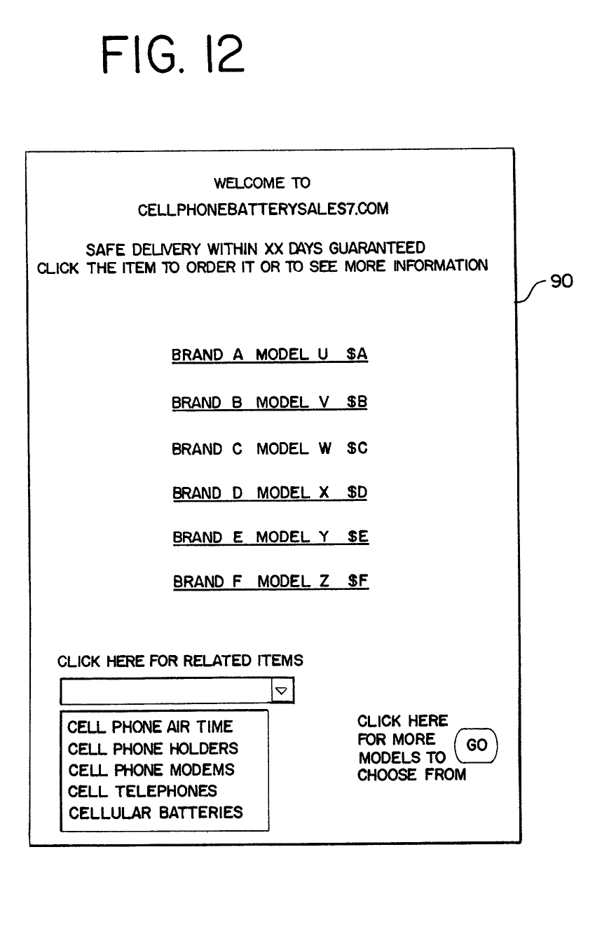

Nonetheless, for some lower-capacity devices interconnected to the Web, the Web page of FIG. 6 may still be too complex. The complexity may cause the screen to be distorted or not displayed at all. Alternatively, the cards on the displays of such devices may be difficult to read or to navigate by the user. Accordingly, in another embodiment, the contacted server recognizes the low capability of the PDA, WAP telephone, cellular telephone or other device computer and modifies the content provided accordingly. An exemplary screen 90 with modified content for a low capability user device is shown in FIG. 12. Such modified content may include, for example, a pixel pattern (or smallfont text) rather than a standard text file or may include, for example, a brief description rather than a photograph.

In one embodiment, the Web page of FIG. 6 includes a header or other information, typically transparent to most users. The header provides information on how the font may be downsized to fit on a smaller screen.

The use of the item linking commands (item descriptor; common extension; protocol extension(s)) allows for a large variety of different pages, where each is targeted to a purchaser seeking a specific item. This, in turn, allows the pages to be less cluttered and more easily converted to a smaller number of screens for limited capability devices.

In another embodiment, the Web pages of the system 20 employ the Wireless Markup Language (“WML”). WML allows a wireless device to more easily convert the page into a deck of multiple WML cards that fit on a wireless device. Clearly, the less cluttered the page is, the fewer WML cards that will be needed and the easier, and more intuitive the shopping process will tend to be.

Further, the Wireless Application Protocol (“WAP”) Forum has made public a substantial amount of information regarding common standards. In another embodiment, some of these common standards are employed by the system 20. See also, Transcoding Internet Content for Heterogeneous Client Devices by Smith, Mohan and Li Proceedings ofIEEE International Conference on Circuits and Systems, May, 1998, which is incorporated herein by reference.

2. Alternative Spell Assist

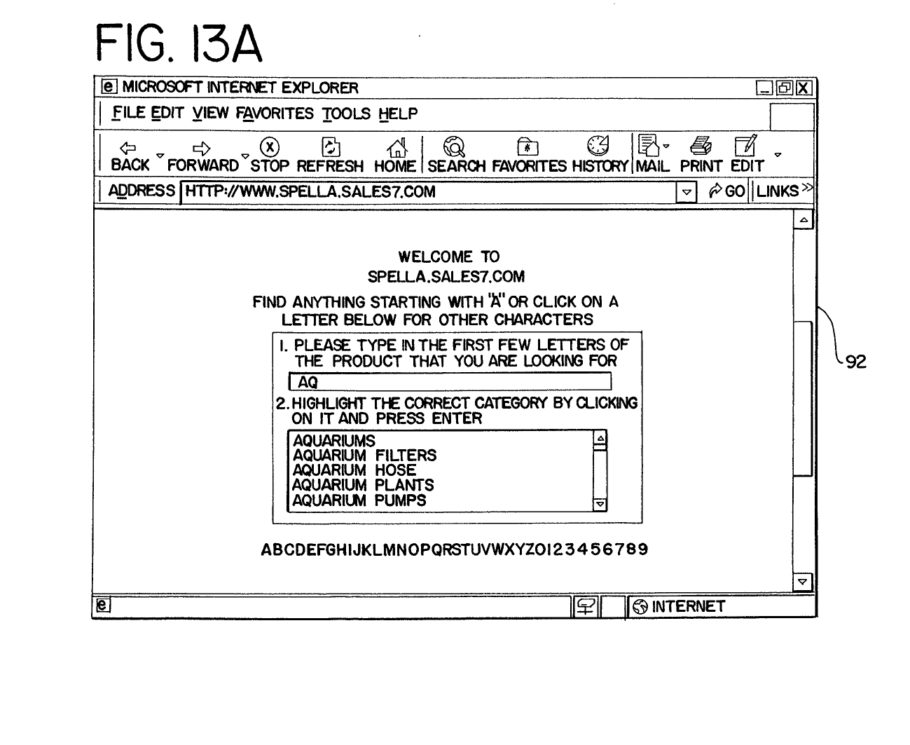

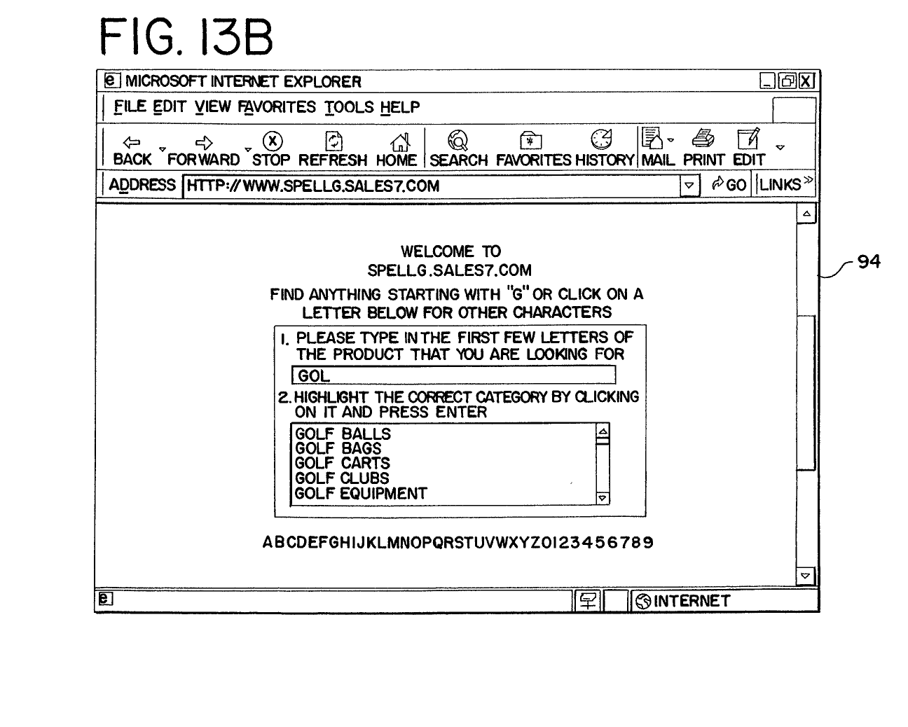

Occasionally, a consumer may be unaware as to how to spell a particular product. In such a case, one of the servers may host a “spelling assist” page, to promptly help with the spelling of the item of interest and promptly link the user to the appropriate page/site. Such help may take the form of the Web pages 92, 94 shown in FIGS. 13A and 13B. Upon reaching the page, spella.sales7.com, the item identifiers beginning with the letter, A, are set forth for the user. Further, the user may enter, for example, the second and third letters of the product or service of interest, and a listing of products or services beginning with the entered letters will appear in a drop down index. The user need then only highlight the item of interest, and the system 20 will transfer the user to the appropriate system Web page. A similar process occurs when the user requests the page, spellgsales7.com, and item identifiers beginning with the letter, G, are displayed.

In one preferred embodiment, the system 20 includes a variety of spell assist pages having an address of the form, item descriptor and common extension. The item descriptors are made up of the series: “spella”, “spellb” “spellc” ... “spellz”. In another embodiment, the series of item descriptors also includes the series: “spell0”, “spell1”, “spell2” . . . “spell9”.

3. Single Visit Shopping Option

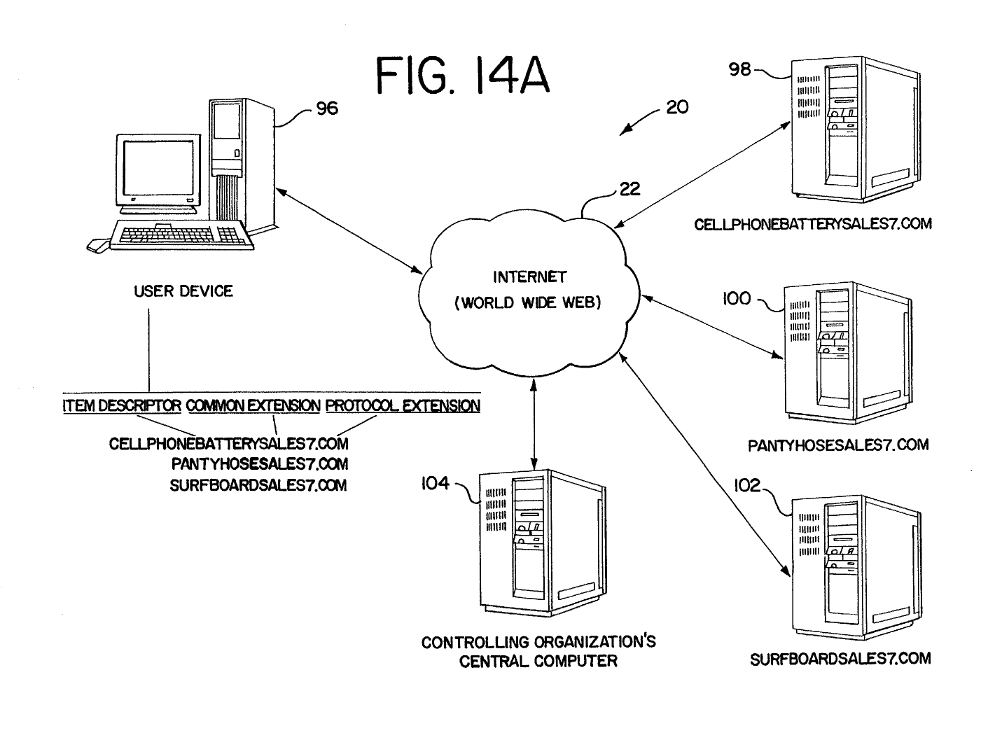

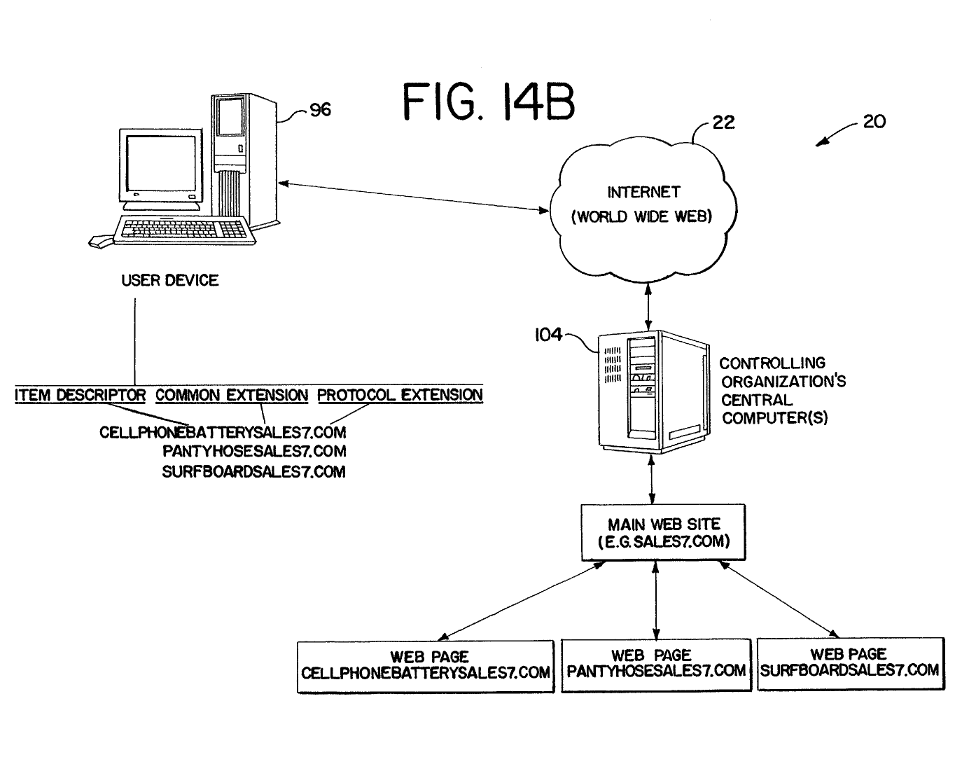

As demonstrated in FIGS. 14A-14D, a user may enter the address, “cellphonebattery.sales7.com” (or the address, “cellphonebatterysales7.com”) onto the command/address line of a browser. The user may or may not then purchase a cell phone battery. Upon completing a visit to the Web page for “cellphonebattery.sales7.com” (or “cellphonebatterysales7.com”), the user, or consumer, may wish to purchase a separate item, such as pantyhose. In such a case, the consumer need only enter onto the command/address line of her browser: “pantyhosesales7.com” (or “pantyhose.sales7.com”). She will then be sent to the Web page/site for panty hose. Thereafter, the consumer can type in the command/address line of the browser, “surfboard.sales7.com”, and buy a third item.

FIG. 14A shows a user device 96, as well as first, second and third servers 98, 100, 102, which, respectively, host the sites for “cellphonebattery.sales7.com”, “pantyhose.sales7.com” and “surfboard.sales7.com”. When the user enters one of these three Web addresses, the appropriate server displays to the user an initial page showing the item of interest. When the user orders a product, the responsive server 98, 100 or 102 logs the order, which is then periodically reported to the central computer 104. The central computer 104, one of the servers 98-102, or a separate, secure computer may processes the credit card information.

An alternative embodiment of the system 20 is shown in FIG. 14B. In this alternative, the actions of the user, and content displayed on the user's computer, are the same as that in the embodiment of FIG. 14A. In the more preferred embodiment of FIG. 14B, however, the various Web addresses entered by the user point the user's computer to single Web pages within the main Web site (e.g., sales7.com) hosted by the controlling organization. The Web site then promptly displays for the user the Web initial page.

Analogous embodiments of the system are shown in FIGS. 14C and 14D. With these examples, the user enters her request, followed by the extension, “.sales7”, and the protocol extension, “.com” to obtain items over the Internet.

In embodiments of the system 20 described above, a Web initial page is promptly provided to the user when the user enters a browser command/address of the form having an item descriptor from a diverse family and a common extension. In the embodiment of FIG. 14A, different (real or virtual) servers host different Web sites that correspond to the URLs entered by the purchasers, and the home page of such sites are initial pages. In the embodiment of FIGS. 14B-14D. the initial pages are hosted by the controlling organization's Web site (or Web sites). In most cases, the address of the controlling organization's Web site will not correspond to the URL entered by the user. Rather, the URLs entered by the user simply point to the appropriate initial pages on the controlling organization's Web site (or Web sites).

In all embodiments described, the same information is provided to the user after the user takes the same number of actions. Whether the same or different computers host the initial pages is not apparent to the user.

In the (“non-dot”) example of FIG. 14A, the controlling organization has undertaken to reserve the family of Web addresses that include a diverse family of item descriptors. The latter (“dot”) alternative of FIG. 14B, however, may be easier to administer. In another variation of the system 20, the controlling organizations utilizes the “dot” approach of FIG. 14B, but also maintains a family of Web addresses such as those shown in FIG. 14 A. The “non-dot” pages include pointers to the corresponding “dot” Web pages in order to reduce user confusion and increase system reliability should a user fail to insert a dot between the item descriptor and the common extension.

Eventually, after visiting the Web sites described in FIG. 14A-14D, the user will either log off her computer 96 or go to another site that is not supervised by the controlling organization which oversees the large family of Web addresses/pages and/or sites in the system 20. Before logging off or going to a site outside of the system 20, the user will typically have been asked for purchaser information. If no purchaser information is given, the order is kept on file for a set amount of time before being deleted.

The central computer 104 may or may not host a Web site. If additional computers are used (which, of course, is not required), the computer 104 is in communication with the other servers to receive updates on any purchases that the user may have made at the Web pages/sites hosted by the servers.

4. Confirmation and Later-Marketing Options

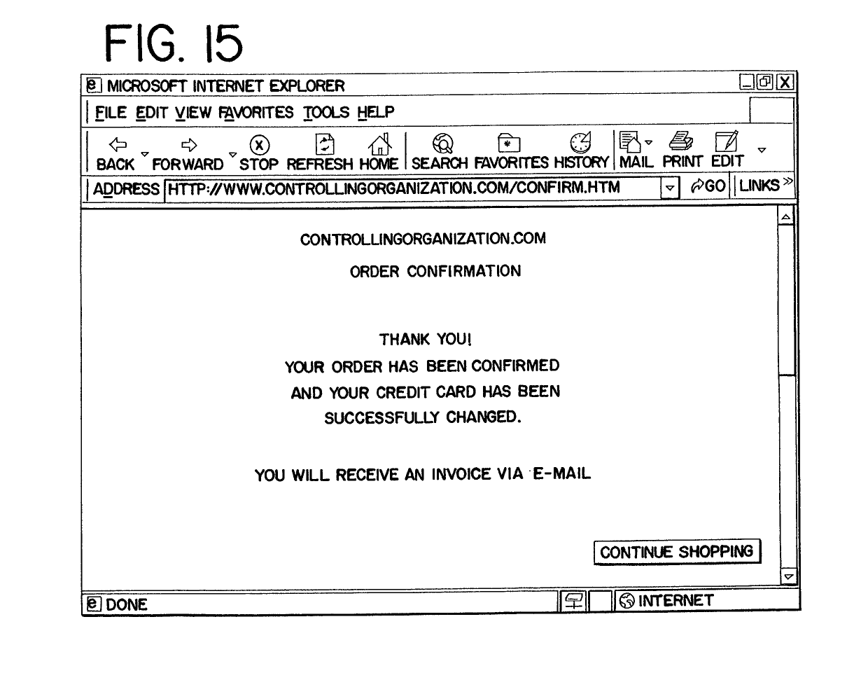

In another embodiment, one or more of the servers handling purchases 98-102, or, alternatively, the central computer 104, may issue a message (such as E-mail) to the user. The message advises the user that the sale has been completed. The message may also confirm the details of the sale, such as the quantity, price, features of the product, and, in one preferred embodiment, that the product shipment is guaranteed or insured to arrive with a specified number of days. An exemplary confirmation message is shown in FIG. 15.

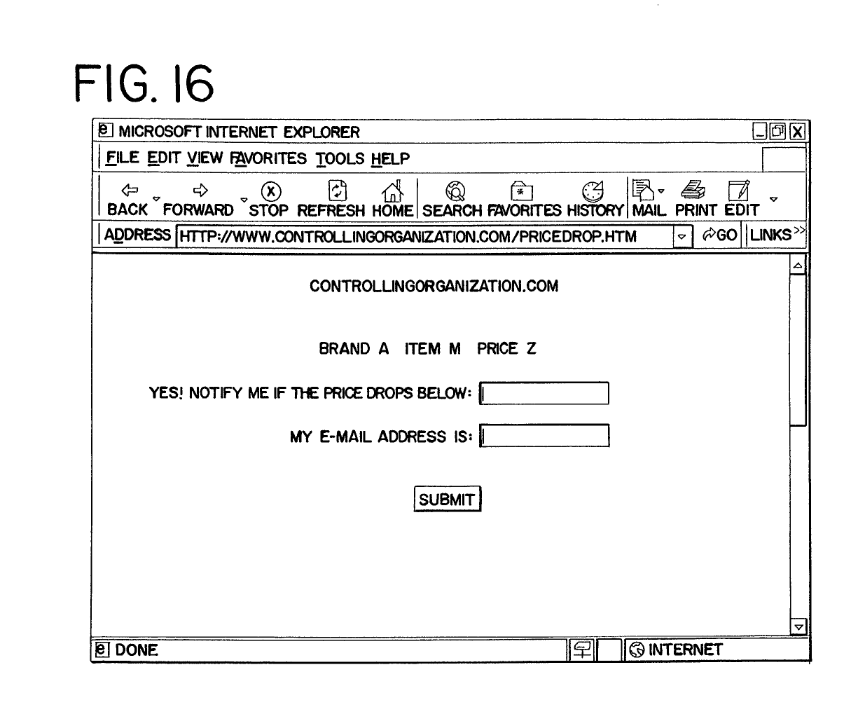

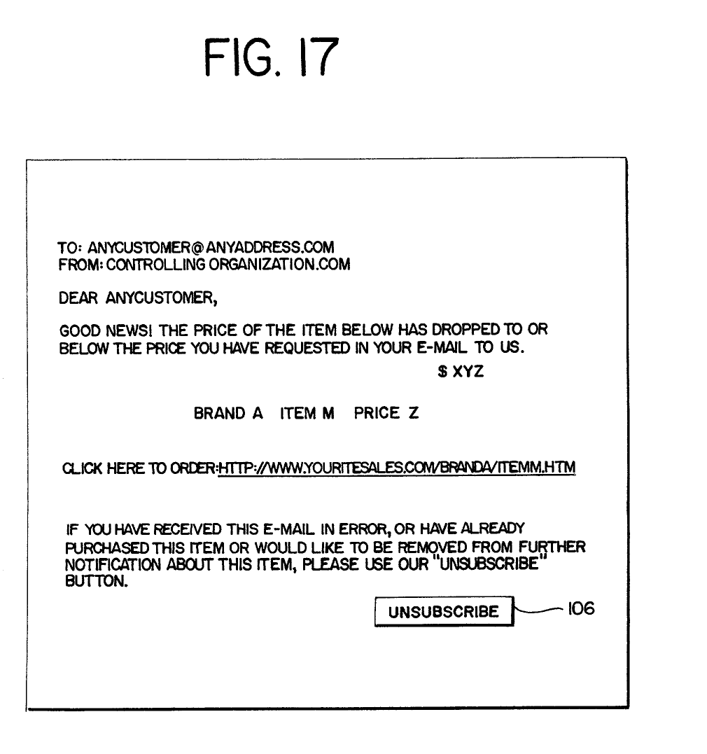

As discussed above, one of the computers 98-104 may also ask the user whether she would like to be notified, via E-mail or regular mail, of, for example, future sales or when a price drops to her preselected level. This provides for good, direct, follow-up marketing later, after the seller has made a purchase or declined to make a purchase. FIG. 16 shows an exemplary page making a request of a user. FIG. 17 shows an exemplary notification provided to a user when the conditions specified by the user in response to the request of FIG. 16 have been satisfied.

Notably, the page of FIG. 17 includes an unsubscribe button 106. The button 106 may be easily activated by the user and allow her to stop the system 20 from transmitting to her unwanted notices.

Thus, the issuance of a request to learn whether or not the consumer wishes to be notified of future sales gives the consumer the option of deciding whether she wants to be a target of further direct sales. Some customers may object to such marketing, and the response to the request can prevent the system 20 from annoying such customers. Others, however, may appreciate the direct sales, and the inquiry can assist the system 20 in taking advantage of a direct marketing opportunity. This further helps the system to be “sticky” (likely to be used again).

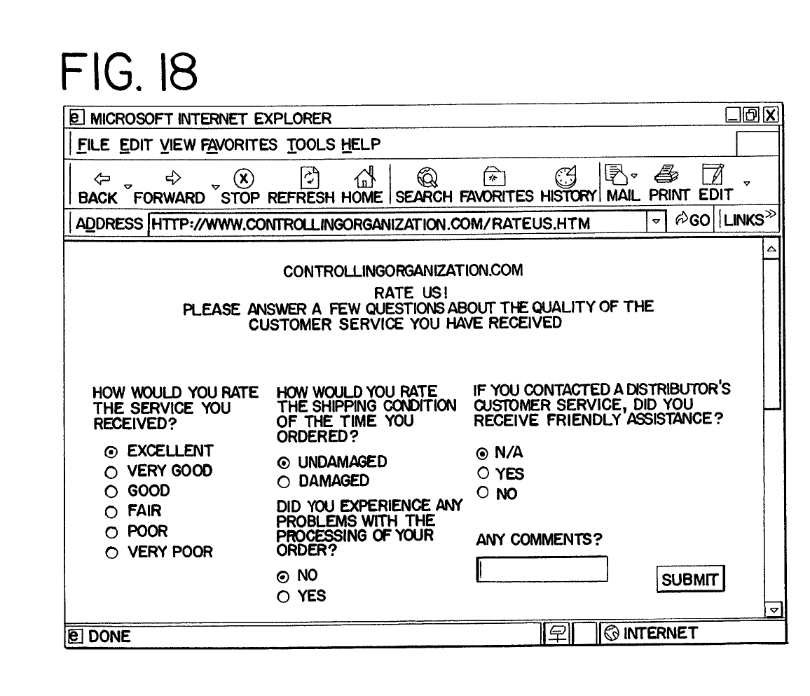

The system 20 may also generate for the user an “after-the-sale” follow-up message to the user. An example of such a message is shown in FIG. 18. The controlling organization may send out such a message, for example, a week after the purchased item has been shipped to the user. By monitoring the response, the controlling organization may better control the quality of its services.

The system 20 does not necessarily require the user to enter her purchaser information after every buy decision. Rather, the system may only require such information before the user moves to a site not under the control of the system 20. Thus, the system 20 may employ a virtual, “intelligent shopping cart” that may follow the user as she views system Web pages.

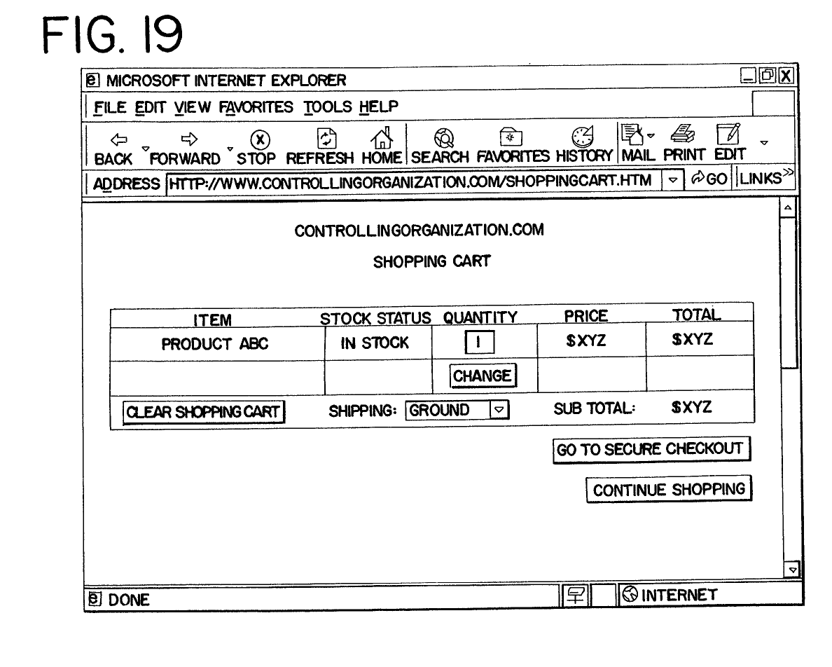

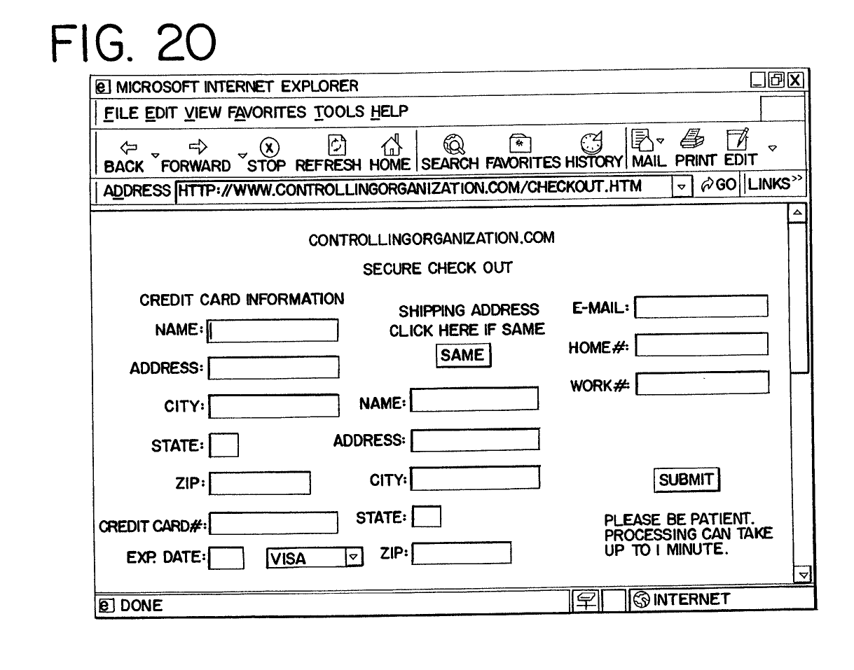

The system 20 keeps a running total of the amount owed by the purchaser for the items selected during the most recent visit to the system's family of Web pages or Web sites. A shopping cart screen, such as that shown in FIG. 19, may display the running total and allows the user to eliminate an item from the “shopping cart” (list of item selections during the current visit to the system 20). Generally, before the user logs off the Internet or before she visits a site outside of the system, the system 20 asks for the purchaser information. See the exemplary request shown in FIG. 20. The items then in the “shopping cart” are then effectively purchased, and the total amount due for the most recent sequence of visits to the family of Web sites/pages in the system 20 are charged to the user's account. Accordingly, there need be only one charge card transaction for many different purchases during a single sequence of visits.

Controlling, or Central, Organization

1. Generally

In the example described above with respect to FIG. 14, multiple organizations may be responsible for shipping the cellular telephone battery, panty hose and surfboard from the user's visits to the three separate Web sites/pages. A user, however, will tend to be more confident in making such purchases because, if anything should go wrong with any of the purchases, the customer may need only contact the one central, or controlling, organization. As long as the controlling organization has a good business reputation, the purchaser can buy without concern about the trustworthiness of the various vendors.

In an alternative embodiment, the Web initial page of FIG. 6 is promptly supplied to the user upon the entry of an item descriptor onto the address/command line of a browser. In an alternative embodiment, the controlling organization itself does not offer the items for sale, but, instead, provides a distributor page 108 such as that shown in FIG. 21. As described above, in either alternative embodiment, the Web page shown in FIG. 21 may be considered an initial page.

In such an alternative embodiment, the primary items 111 in the Web page of FIG. 22 are actually items in the Web pages of third-party Web sites that supply the described products. When activated, each such item or link will transfer the purchaser to the specific page of the third party Web site where the item may be purchased.

In such a case, the controlling organization functions as a portal to the specific Web page of another business that sells the item of interest. The controlling organization may receive a commission for referring the user to the other business' Web site (a “clickthrough“commission) and/or for any purchases that the user makes at the other Web site (a “straight” commission).

As shown in FIG. 22, a separate, distributor page 110 may be presented to the user, as an overlay of the controlling organization's Web page 108. The user thus still has not roamed outside of the system 20 and, upon closing out the distributor's page 110, still remains at the system's distributor page 108.

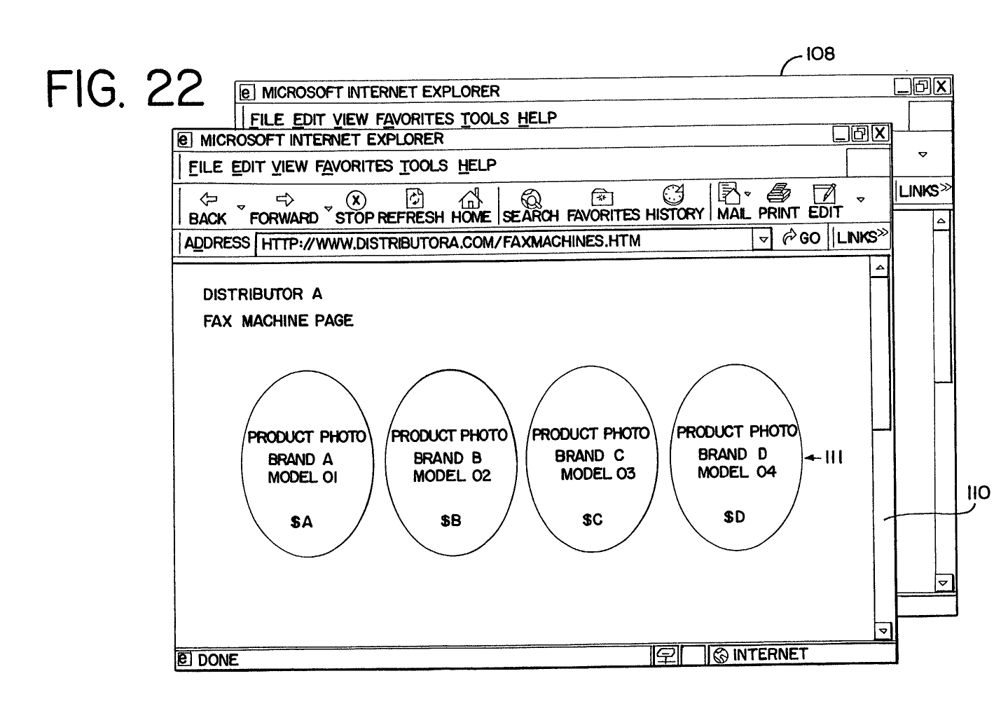

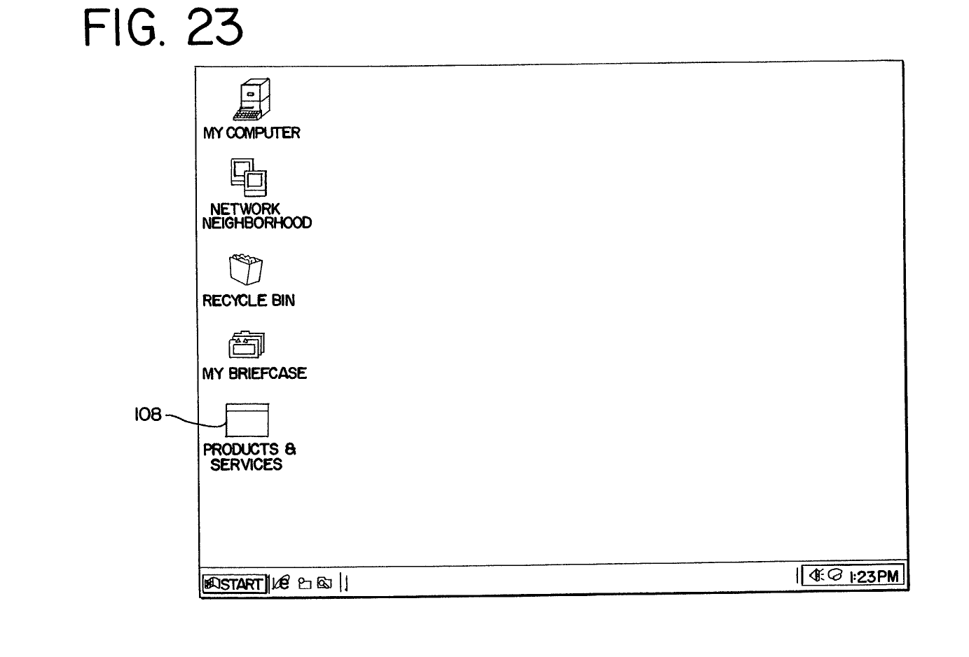

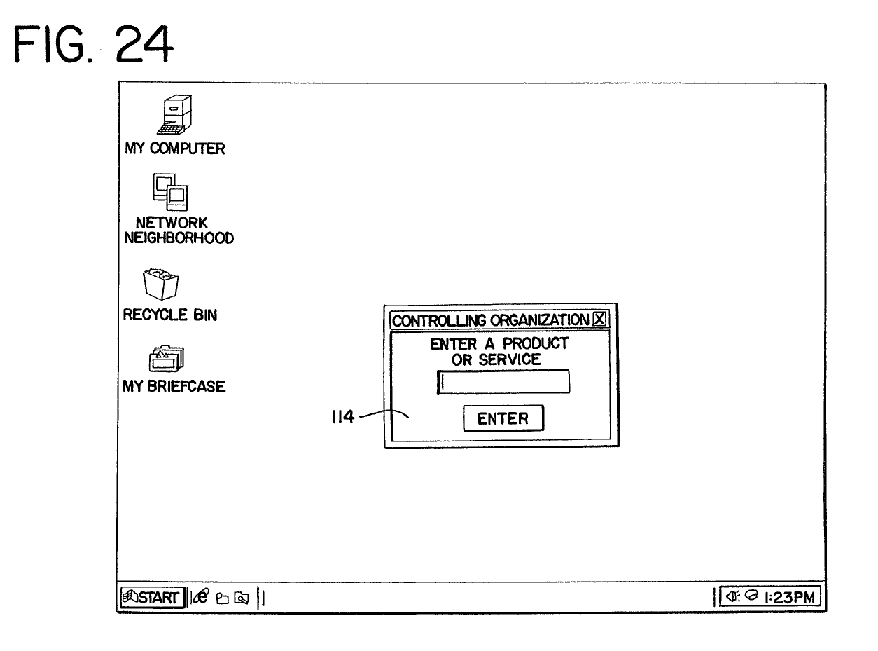

As a further aid to users of the system 20, the controlling organization may distribute to users a small program to be loaded onto the users' computers. Once loaded, the small application on a user's computer may cause a products and services icon 108 to appear, as shown in the representative screen display of FIG. 23. When activated by the user, the icon 108 causes a system address request 114 of FIG. 24 to be presented to the user. The user may then simply enter an item descriptor (such as, e.g., “guitar”). The small application then adds any necessary common extension and/or protocol extension (such as, “.sales7.com”), launches the Internet browser already on the user's computer, and loads the full request (item descriptor, common extension and protocol extensions) into the browser. The initial page is then responsively displayed. Consequently, the user more easily and more quickly views the Web initial page of the system 20.

With the small application represented in FIGS. 23 and 24, the user can generally be assured of only viewing sites within the system 20 (which, for example, are backed by the controlling organization and do not include offensive pages). The small application may achieve this result by at least three different methods.

In one case, the application simply enables the user's computer to transmit a handshake signal to a Web site contacted by the user's computer and await a reply. If the reply does not match a predetermined code, the Web site is not within the system 20, and the user is requested to enter a different item descriptor.

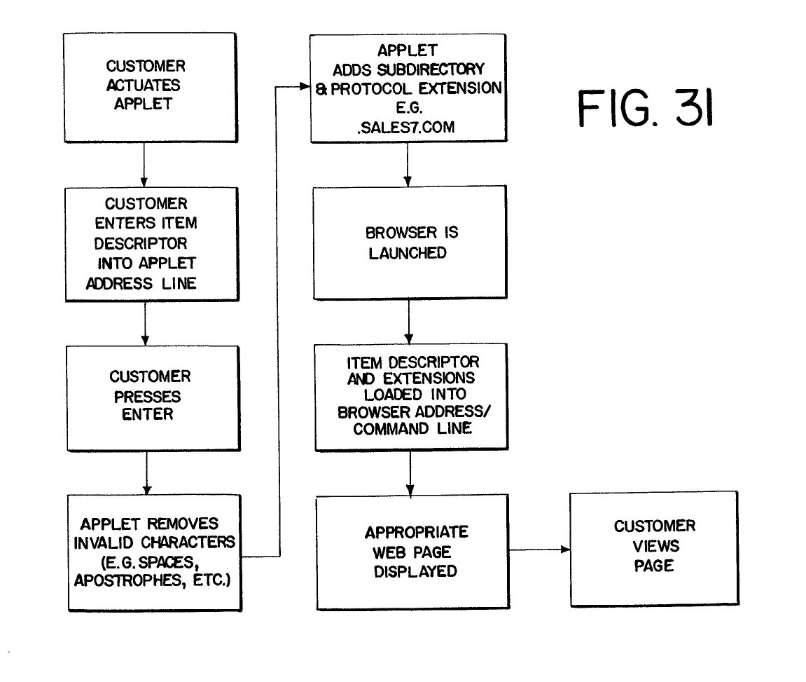

In another embodiment, the application on the user's computer includes a file of every Web site in the system 20. If the item descriptor entered is dissimilar to any system site addresses, the user is again requested to enter a different item descriptor. In another alternative embodiment, the application removes non-alphanumeric characters (such as an apostrophe or space) and adds a common extension (such as “.sales7.com”). See FIG. 31.

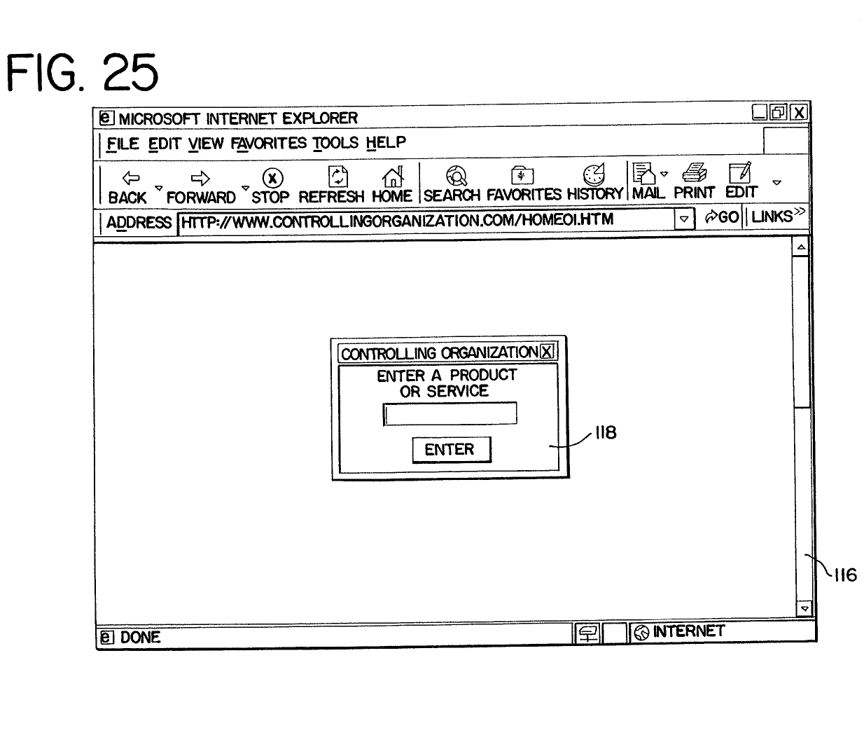

In yet another alternative, a user may simply view the Web home or search page of the controlling organization, as shown in FIG. 25. The home or search page 116 also includes a system address request, onto which a user need only enter an item descriptor (such as, e.g., “guitar”). The controlling organization Web site adds the common extension and protocol extensions (such as, e.g., “.sales7.com”) and interconnects the user to the appropriate page within the system 20.

2. Controlling Organization Activity

As shown in FIG. 14, the central computer 104 of the controlling organization periodically assembles information regarding past orders. The central computer 104 may also periodically issue sales reports on such orders.

The controlling organization may also be responsible to the consumers for any complaints. The consumer would have one entity to contact (either in person or via telephone, written letter or E-mail) if she has any complaints regarding the product, service or transaction. In another embodiment, the controlling organization may contract with individual vendors to provide customer service on behalf of the controlling organization.

The controlling organization may, for example, institute a policy for returns to ensure that a consumer who is dissatisfied with any of her purchases will have only one organization that she need contact to arrange for the return of the unsatisfactory products. The controlling organization may also then be responsible for ensuring that the consumer's credit card account is debited and that the various suppliers of the items purchased with the system 20 are paid.

The controlling organization may also assemble and report on the demographic information collected from monitoring sales and purchasing activity by users. The controlling organization may also generate reports regarding, for example, the most popular Web sites and products, what products or services users have attempted to find but did not; and what entry words have been entered by users but for which no associated key word was found by the system.

The system 20 promotes a more efficient method of transacting E-commerce. The system 20 is intended to make on-line shopping easy and reduce obstacles for the more widespread reliance upon the Internet for commerce.

The controlling organization may wish to promote itself as a single, trustworthy organization that may be relied upon for sales of a wide range of products and services over the Internet. Just as the purchasers have a single entity to contact if their sales transactions were unsatisfactory, vendors need not deal with a large number of various purchasers throughout the country. The suppliers of products need only look to one entity, the controlling organization, for payment. Moreover, the vendors may need not take substantial action (such as maintaining a Web site) in order to receive orders from the controlling organization. The system 20 provides a breakthrough opportunity for easy and efficient Internet commerce. In one embodiment, both consumers and suppliers need only look to a single entity for assurance that the transactions will proceed smoothly.

The controlling organization may also provide insurance on all shipments from the supplier to the consumer as well as credit card fraud insurance and otherwise provide assurances to the consumer that she will obtain the products that she ordered. The controlling organization may also promise that the product ordered will be shipped within, e.g., one day. If vendors do not follow such guidelines, the controlling organization may discontinue involvement with the supplier.

3. Revenue Generation

In one embodiment, the system 10 generates revenues from licensing fees. The IES, the small-program (e.g. applet) software residing on a user's computer which assists with usage of the system 10, and the dot-system technology may all be licensed to generate fees.

A custom applet (with custom artwork and custom functionality options) may be designed and licensed to different licensees. Internet businesses with such licenses may then pay licensing fees, renewal fees, and subscription fees by which their software is monitored, maintained and/or updated by a central, licensing organization.

The system software and database(s) may be housed on the Internet business' own server(s) or on additional server(s) either provided by the licensing organization or the licensee. (Such additional servers may be located either on or off the site of the Internet business.) Where an Internet business itself houses the software and databases, the Licensing Organization may remotely monitor and maintain the software and databases, and provide updates, via data lines.

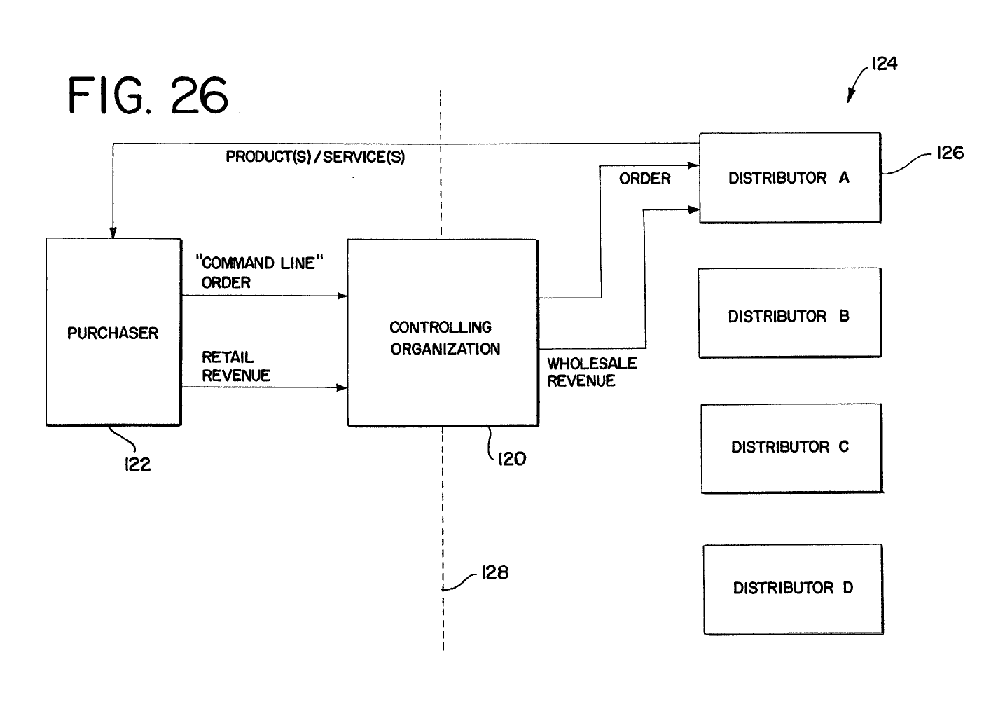

The Internet business may obtain substantial benefits from such a licensing arrangement. In addition to the system's functionality (solving search problems commonly associated with many sites), the licensees benefit from keeping an icon on their customers' computer screens. Thus, an icon representing their brand identity is kept in front of their customers. The small program/applet may be imaged onto computers by computer manufacturers or distributed, for example, via an Internet download, direct mail CDs, point of purchase CDs, or other media. (Such distribution may also, of course, be a source of revenue for the licensing organization.) For another exemplary revenue model, a controlling organization is shown in the block diagram of FIG. 26. The controlling organization 120 may log orders from a purchaser/computer user 122 (via the central computer 104 and Internet 22) and then, in turn, issue orders to various distributors and manufacturers 124 for the products and services that have been ordered. Such requests may include purchaser information.

Although the particular distributor 126 chosen by the controlling organization 120 ships the ordered product directly to the purchaser 122, the distributor 126 looks only to the controlling organization 120 for payment. Similarly, the purchaser 122 looks only to the controlling organization 120 as the place at which to place her order, to pay for the purchase, and to ensure that the transaction proceeds smoothly. There is, in effect, a curtain 128 between the purchaser 122 and distributor 126, since each looks only to the controlling organization 120 regarding all financial aspects of the transactions conducted with the system 20.

In an exemplary embodiment, the orders to manufacturers are made electronically by the central computer 104 to the manufacturers' computers, which are also connected to the Internet. The supplier chosen by the central organization to fulfill an order for any one product or service may be the controlling organization itself or may be a separate manufacturer or supplier.

The controlling organization 120, of course, may earn revenues with a traditional storekeeper model by arranging generally to sell an item at retail price that is higher than the wholesale price from the supplier. Thus, the system 20 allows the controlling organization 120 to oversee an electronic version of a general store.

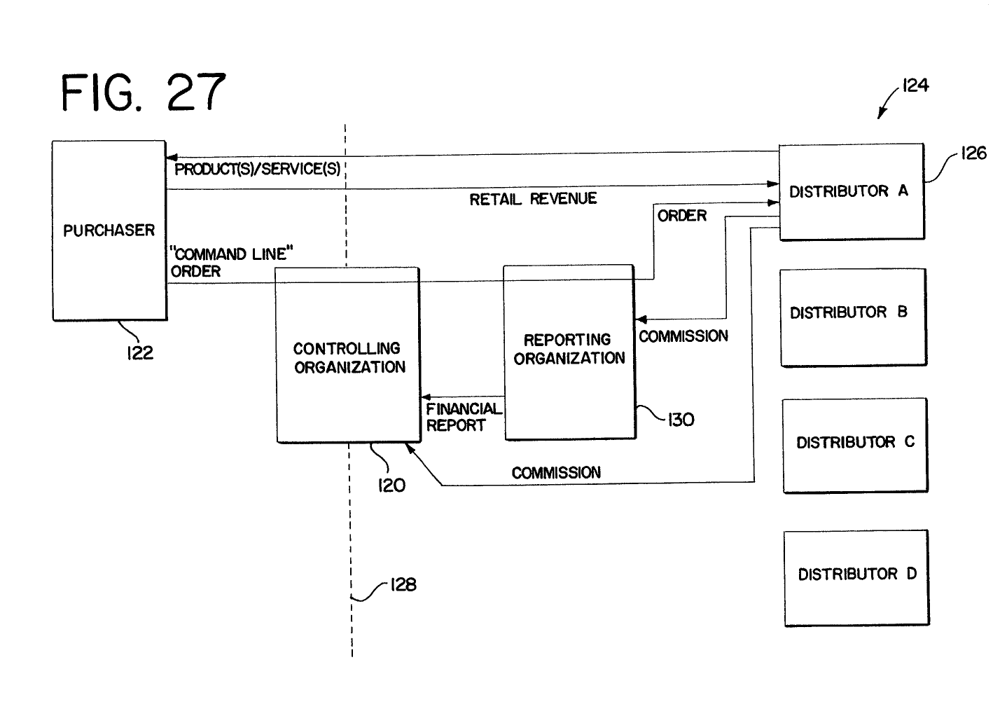

Another exemplary revenue model for the controlling organization 120 is shown in FIG. 27. In the embodiment of FIG. 27A, the purchaser's order may flow directly though the controlling organization 120 to a reporting organization 130, which monitors the order sent by the controlling organization 120 to a selected distributor 124. The distributor 124 both ships the product to the purchaser and looks to the purchaser 122 for payment. The distributor 126, in effect, then pays a commission to both the reporting organization 130 and controlling organization 120 for their efforts in effectively referring a sale to it. The reporting organization 130 may also provide financial reports to the controlling organization 120 regarding the sales that have been referred to the distributors 124.

Moreover, the controlling organization may, for a fee, place advertisements for third-party businesses on some, or all, of the Web pages that its presents. Such “banner ads” may thus also be a source of revenue for the controlling organization. In addition, the controlling organization may obtain “click through” revenues from referrals to third party Web sites.

FIG. 27B shows an exemplary model where the controlling organization may receive revenue in the form of advertising fees from retailers and as commissions and slotting fees. In particular, the controlling organization my display on the user's computer advertisements (such as, by way of example only, “banner ads”). Such advertisements need not be static or the same for every user. In contrast, the advertisement can be targeted to a particular user's request. Further, the advertisements may include a deep link to the appropriate page of an advertiser's Web site. Advertisers, of course, may pay the controlling organization for such advertisements.

Should, for example, a user seek “dog food” as an item over the Internet, the system might then, for example, display targeted advertisements on the user's computer relating to items that the user making the particular request is likely have interest in: E.g., dog food or dog grooming supplies. The system 20 does not display, and the manufacturer of dog grooming supplies need not pay for, an advertisement for dog grooming supplies that is displayed to every user of the system. Rather, the system 20 may display advertisements to users who are in a “target audience” previously identified by the purchaser of the advertising. The advertisements may reach a more limited audience, but such an audience is more likely to be influenced by the advertisement. This is because the users' item requests may reflect a desired predisposition, such as a predisposition to purchase items relating to dogs).

In a blanket campaign, an advertisement is shown to every user. However, in a targeted campaign, the ads are shown to only a fraction of the total number of users. Consequently, the purchaser of the targeted advertisement may pay a lower total amount for advertising than if she were to purchase a blanket advertisement campaign. However, an advertisement actually shown to a targeted user is likely to be more valuable any one ad in a blanket advertising campaign. The system 20 thus allows the issuance of granular, product-specific advertisements to particular users who are likely to have interest in the product. Thus, the manufacturer may be willing to pay more per advertisement in such a targeted campaign than in a blanket campaign.

The controlling organization may well choose not to require a vendor to pay any commission, slotting fee, etc. in order to receive referrals from the controlling organization. Nonetheless, some vendors may chose to direct revenue to the controlling organization in order to obtain advertising from, or positions of greater prominence within, the system 20.

Encryption methods for protecting the security of credit card numbers transmitted over the Internet 22 are employed with the system 20. In addition, the controlling organization may provide assurances to the purchasers that their credit cards will not be overcharged. Alternatively, the controlling organization 120 may arrange for the receipt of checks from purchasers (or for other money transfer mechanisms) in order to ensure payment is made for purchases made on-line.

Similar Design of the Family of Sites

The controlling organization 120 may also oversee a family of Web pages and/or Web sites that may have a similar, uncluttered look. Such pages are relatively easy to duplicate from one to the next. Further, the visual appearance of the pages will also be readily recognizable as belonging to the controlling organization 120 and be easily formatted for downloading to a device with limited capabilities.

Operation of the System 20

As shown in FIG. 28, a user may utilize the system 20, in a general sense, by activating the browser of a computer and then entering the item descriptor, common extension and protocol extension onto the address/command line. If the item descriptor does not have multiple meanings, she will then promptly view the Web initial page, such as that shown in FIG. 6. If multiple meanings do exist, the user may view routing pages, such as those shown in FIGS. 10 or 11, before arriving at the Web initial page.

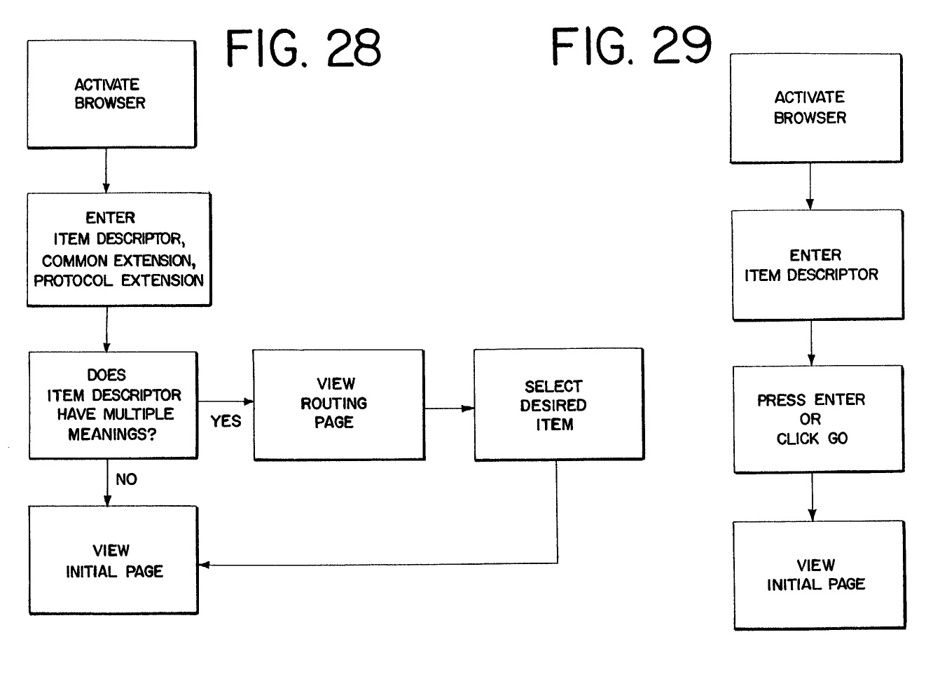

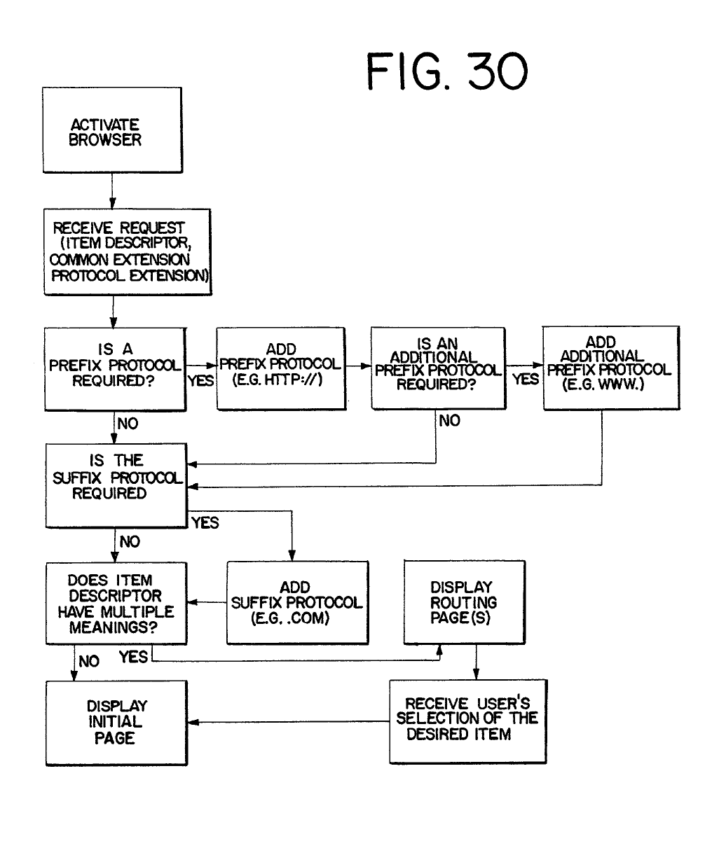

As shown in FIG. 29, the user may, in some cases, simply enter the item descriptor onto, for example, the address/command line of a browser adapted to the system 20. Such browser command lines are shown, for example, in FIGS. 24 and 25. In such a case, the user's computer may follow the steps shown, for example, in FIG. 30, to add the common extension and the protocol extensions, so that the user may view the Web initial page. The steps that a user would take with such a small application loaded onto her computer are shown in FIG. 31.

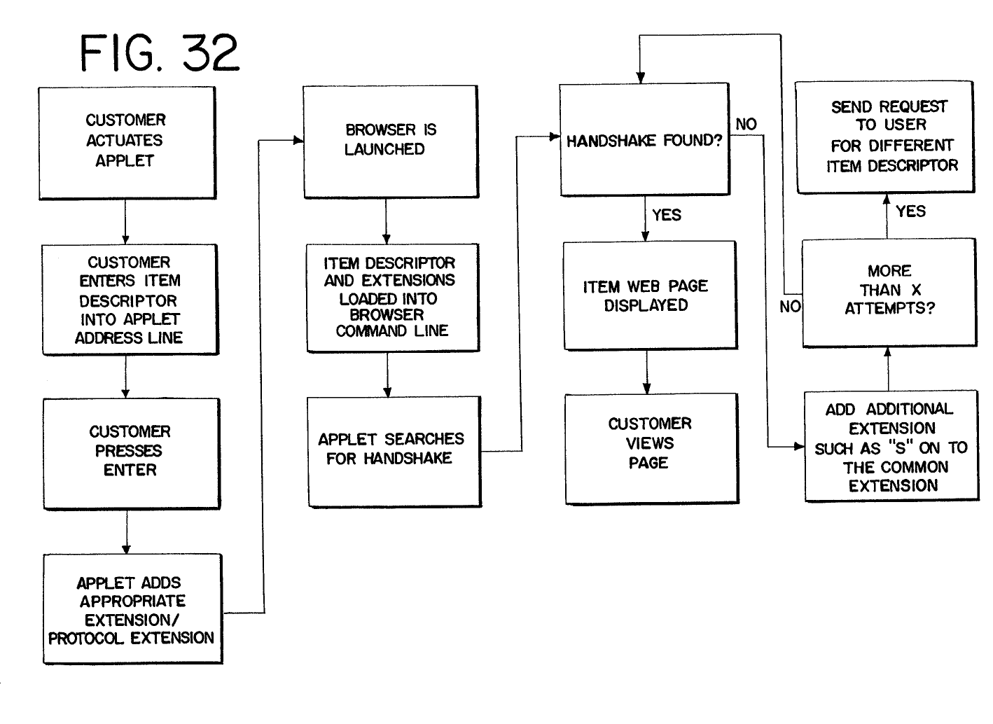

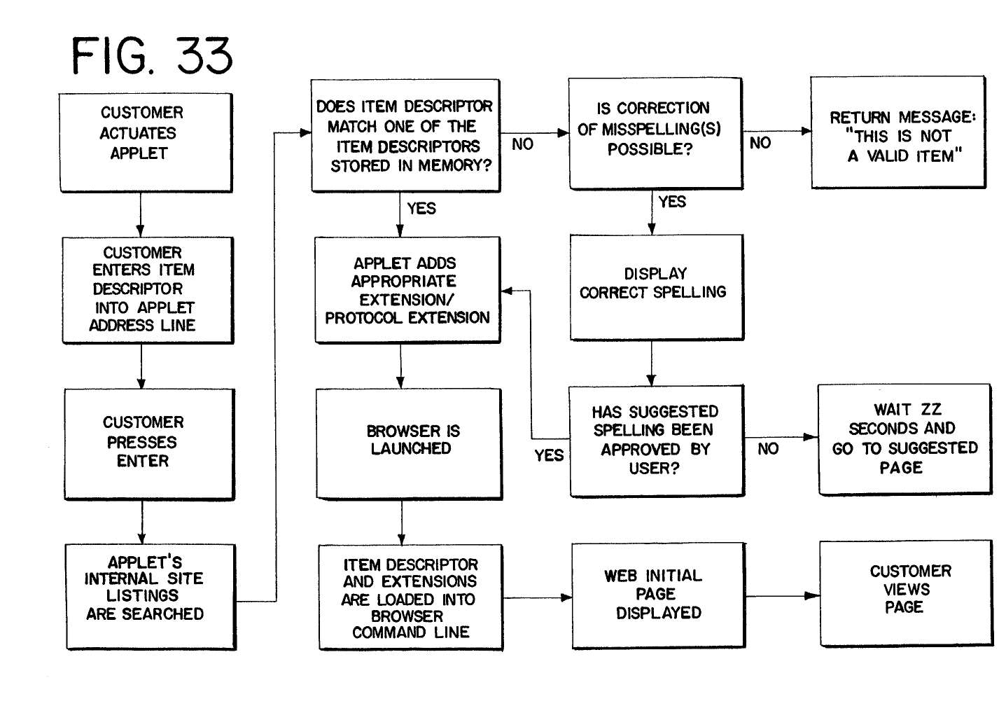

Exemplary steps taken by an application on the user's computer to add the common extension and protocol extensions are shown in FIGS. 32 and 33. FIG. 32 shows the steps for a small application that searches for a handshake from a Web site to confirm that it is a member of the system 20. FIG. 33 shows the steps for a small application that has loaded into the computer's memory an updated list of current pages that are members of the system 20.

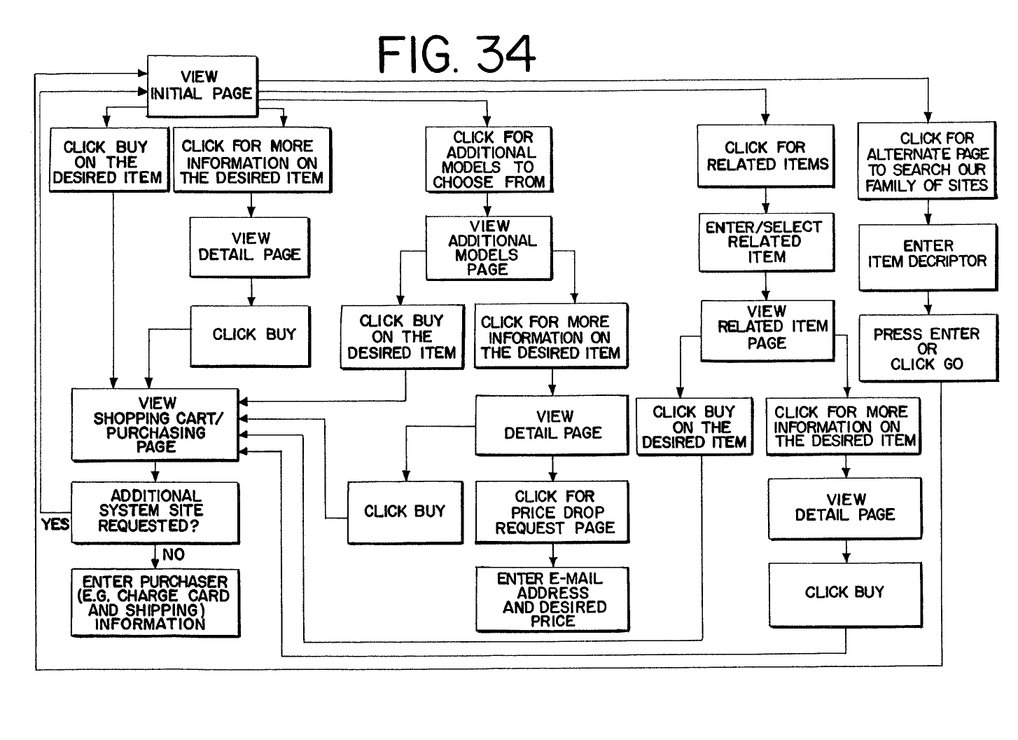

As shown in FIG. 34, once the Web initial page is displayed (see FIG. 6), the user may either buy one of the primary items displayed, request more information on one of the primary items (see FIG. 7), request additional models to choose from (see FIG. 8), request to see information on related items (see FIG. 6) or request a search page to search the system's family of sites (see FIG. 9). The process followed by the system 20 in allowing the user to purchase an item (or a series of items) is shown in FIG. 34.

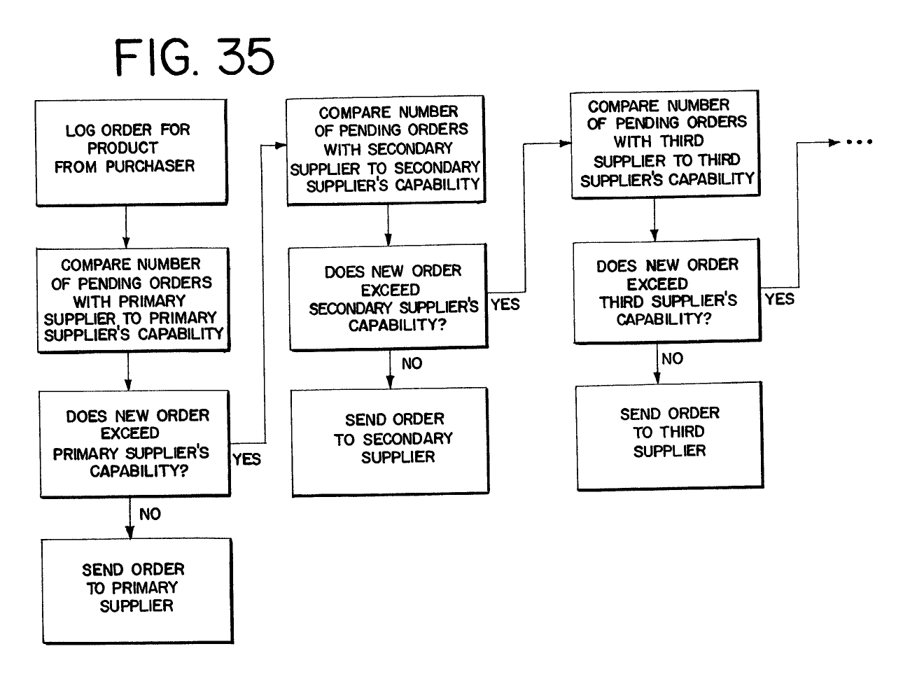

Once the controlling organization 120 logs an order, it may wish to pick a distributor according to the cascading selection process shown in FIG. 35. The controlling organization estimates the capacity of a variety of suppliers or distributors, ranking them in order of preference. The most preferred supplier may have a limit as to the number of orders it may fill over a particular time period. Once the primary supplier's capability is surpassed, the controlling organization then switches to a secondary supplier until, again, her capacity to fill orders properly has been reached. At that time, another supplier is contacted, etc.

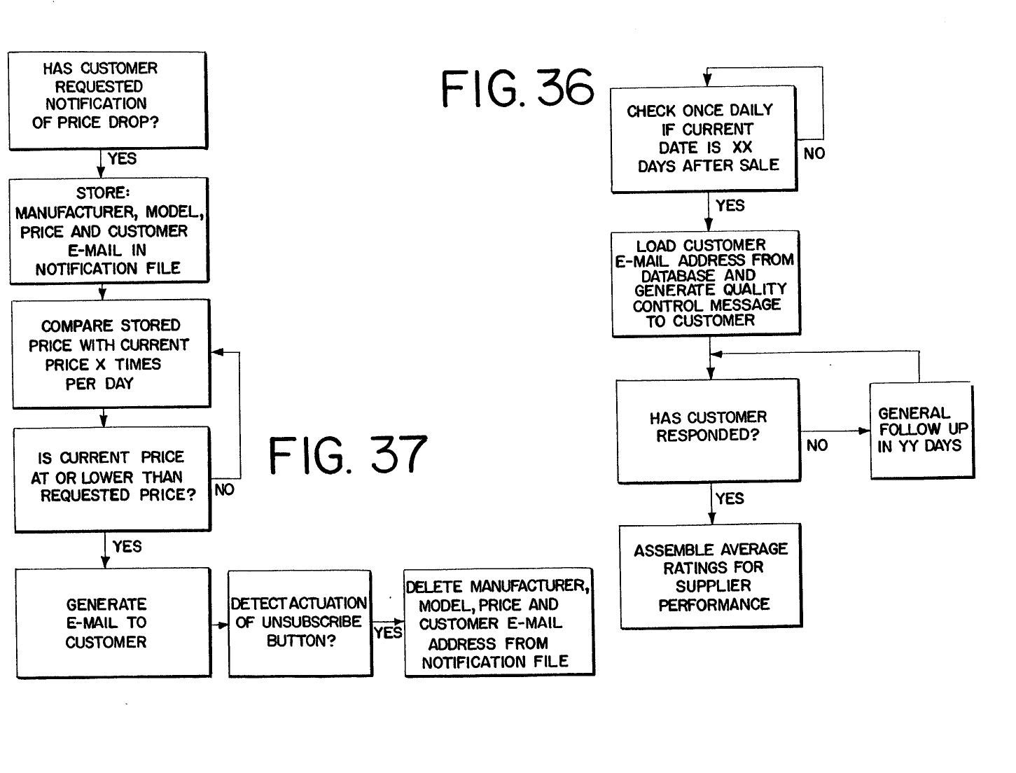

After an order is logged by the controlling organization, a quality control inquiry, such as that shown in FIG. 18 may be sent to the purchaser. Steps for generating such requests are shown in FIG. 36.

Further, should a customer respond positively with a form such as that shown in FIG. 16, the steps of FIG. 37 may be followed by the system 20. In this way, a notification such as that shown in FIG. 17 may be routinely generated for the customer.

Varied Uses for Item Descriptors and Common Extensions

The system 20 may be used not simply for sales, but for any logical grouping of a large number of items available over the Internet. Thus, for example, a common extension could be used to assemble Web pages appropriate to a particular aspect of history. A common extension might then be “history.” The command, chinahistory, could result in a single site directed to historical information about China rather than providing a large collection of information about Chinese culture, Chinese food, or the Chinese language, etc.

Modifications of the System

Preferred embodiments have been described herein. It is to be understood, however, that changes and modifications can be made without departing from the true scope and spirit of the invention. Other embodiments of the present invention, of course, will be apparent to those of ordinary skill in the art upon their review of the detailed description. No one embodiment should be deemed to be controlling, as all embodiments of the present invention are deemed to be covered by the appended claims. Certainly, the invention must be interpreted to encompass technological improvements not yet developed and/or available to the public. The following claims and their equivalents, which are to be interpreted in light of the foregoing specification, define the true scope and spirit of the system.

We claim:

1. A program on a computer of a user for initiating a process, where the computer is connected to a computer network, the process comprising:
generating a search box;
receiving an entry word in the search box;
interpreting the entry word to arrive at a key word;
determining a pre-established association between the key word and an item on the computer network; and
providing the item to the computer of the user.

2. A program as claimed in claim 1 wherein:
the computer network is the Internet, and
the item is a link to a specific page of a vendor.

3. A program as claimed in claim 2 wherein the program launches an Internet browser to provide the item to the user.

4. A program as claimed in claim 2 wherein the search box is generated on a web site of the vendor.

5. A program as claimed in claim 3 or 4 further comprising the step of interpreting the entry word when determining the pre-established association.

6. A program as claimed in claim 5 wherein the step of interpreting the entry word includes searching for a synonym of the entry word (“synonym analysis”).

7. A program as claimed in claim 5 wherein the step of interpreting the entry word includes changing the spacing between characters of the entry word (“space analysis”).

8. A program as claimed in claim 5 wherein an entry word may be expressed as a slang term and the step of interpreting the entry word includes analysis translating a slang entry word into a standard language term (“slang analysis”).

9. A program as claimed in claim 5 wherein different entry words may have the same meaning and such entry words result in the same item being provided to the computer of the user (continuity analysis”).

10. A program as claimed in claim 5 further comprising the step of making a determination of what items are ultimately chosen by users that have entered a particular entry word and wherein the pre-established association is adjusted according to the determination (“trend analysis”).

11. A program as claimed in claim 5 wherein the process includes at least two of the following processes: synonym analysis; space analysis; slang analysis; continuity analysis; and trend analysis.

12. A method for a computer interconnected to a computer network to locate, over the computer network, an item that has been requested by a user of a computer comprising:
receiving an entry word;
associating the entry word with a key word from a diverse family of key words;
determining a pre-established association between the key word and an item on the computer network; and
providing the item to the computer of the user.

13. A method as claimed in claim 12 wherein:
the computer network is the Internet, and
the item is a link to a specific page of a vendor.

14. A method as claimed in claim 13 wherein the program resides on the computer of the user and the program launches an Internet browser to provide the item to the user.

15. A method as claimed in claim 13 wherein the search box is generated on a web site of the vendor.

16. A method as claimed in claim 14 or 15 further comprising the step of interpreting the entry word when determining the pre-established association.

17. A method as claimed in claim 16 wherein the step of interpreting the entry word includes searching for a synonym of the entry (“synonym analysis”).

18. A method as claimed in claim 16 wherein the step of interpreting the entry word includes changing the spacing between characters of the entry word (“space analysis”).

19. A method as claimed in claim 16 wherein an entry word may be expressed as a slang term and the step of interpreting the entry word includes analysis translating a slang entry word into a standard language term (“slang analysis”).

20. A method as claimed in claim 16 wherein different entry words may have the same meaning and such entry words result in the same item being provided to the computer of the user (“continuity analysis”).

21. A method as claimed in claim 16 further comprising the step of making a determination of what items are ultimately chosen by users that have entered a particular entry word and wherein the pre-established association is adjusted according to the determination (trend analysis”).

22. A method as claimed in claim 16 wherein the process includes at least two of the following processes: synonym analysis; space analysis; slang analysis; continuity analysis; and trend analysis.

23. A computer program for displaying an item requested by a user of a computer, the program causing a computer system to implement the method of claims 12, 13, 14 or 15.

24. A series of instructions on a computer-readable storage medium, the instructions enabling a computer system to implement the method of claims 12, 13, 14 or 15.
